(19) United States
(12) Patent Application Publication
(10) Pub. No.: US 2026/0291675 A1
(43) Pub. Date: Sep. 24, 2026

(54) SYSTEMS AND METHODS FOR DEVICE-TO-DEVICE COMMUNICATIONS

(71) Applicant: ZTE CORPORATION, Shenzhen, Guangdong (CN)

(72) Inventors: Mengzhen LI, Shenzhen (CN); Chuangxin JIANG, Shenzhen (CN); Qi YANG, Shenzhen (CN); Yu PAN, Shenzhen (CN); Junpeng LOU, Shenzhen (CN); Cong WANG, Shenzhen (CN); Youxiong LU, Shenzhen (CN); Weimin XING, Shenzhen (CN)

(21) Appl. No.: 19/471,725

(22) PCT Filed: Jul. 31, 2023
(86) PCT No.: PCT/CN2023/110377

§ 371 Date: Oct. 2, 2025

(51) Int. Cl. H04L 5/00; H04W 64/00; H04W 74/08

(52) U.S. Cl. CPC H04L 5/0048; H04W 64/00; H04W 74/0875

(57) ABSTRACT

The present disclosure relates to systems, apparatuses, methods, and non-transitory computer-readable media for performing, by a first wireless communication device, a channel access procedure for at least one channel and communicating, by the first wireless communication device with the second wireless communication device, SL positioning-related transmission using the at least one channel, wherein the SL positioning-related transmission comprises at least one of a SL Positioning Reference Signal (SL-PRS) or a Physical Shared Control Channel (PSCCH) corresponding to the SL PRS.

### CROSS-REFERENCE TO RELATED DISCLOSURE

This disclosure is a national stage filing under 35 U.S.C. § 371 of international application number PCT/CN2023/110377, filed Jul. 31, 2023, and entitled “SYSTEMS AND METHODS FOR DEVICE-TO-DEVICE COMMUNICATIONS”, which is incorporated herein by reference in its entirety.

### TECHNICAL FIELD

The disclosure relates generally to wireless communications and, more particularly, to device-to-device communications.

### BACKGROUND

Sidelink (SL) communication refers to wireless radio communication between two or more User Equipments (UEs). In this type of communications, two or more UEs that are geographically proximate to each other can communicate without being routed to a network (e.g. Base Station (BS)) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

In conventional SL positioning mechanisms, target requirement Sub-meter Accuracy (Set B) cannot be achieved. SL Positioning Reference Signal (PRS) bandwidth is essential for positioning accuracy. For example, up to 100 MHz is recommended for SL positioning in Frequency Range 1 (FR1). However, currently only Intelligent Transport System(ITS) band and licensed spectrum in FR1 are supported for Rel-18 SL positioning. The available bandwidth resources of ITS and FR1 are less than 40 MHz.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating tosystems, apparatuses, methods, and non-transitory computer-readable media for performing, by a first wireless communication device, a channel access procedure for at least one channel and communicating, by the first wireless communication device with the second wireless communication device, SL positioning-related transmission using the at least one channel, wherein the SL positioning-related transmission comprises at least one of a SL Positioning Reference Signal (SL-PRS) or a Physical Shared Control Channel (PSCCH) corresponding to the SL PRS.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication system, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communications, according to various arrangements.

FIG. 3 is a schematic diagram illustrating candidate resource selection for transmitting SL-PRS, according to various arrangements.

FIG. 4 is a flowchart diagram illustrating an example method for communicating SL positioning-related transmission, according to various arrangements.

FIG. 5 is a CAPC table, according to various arrangements.

FIG. 6 is a signaling diagram illustrating an example method for determining SL pathloss based on power control, according to various arrangements.

FIG. 7 is a signaling diagram illustrating an example method for adjusting CW based on measurement result feedback, according to various arrangements.

FIG. 8 is a diagram illustrating an example Type 2 channel access procedure for SL positioning transmission used in COT sharing scenarios, according to various arrangements.

FIG. 9 is a diagram illustrating one COT shared to different responding UEs, according to various arrangements.

FIG. 10 is a signaling diagram illustrating an example method for COT sharing in SL-RTT positioning, according to various arrangements.

FIG. 11 is a diagram illustrating example COT sharing within a group, according to various arrangements.

FIG. 12 is a diagram illustrating an example gNB-to-UE COT sharing in NRU, according to various arrangements.

FIG. 13 is a diagram illustrating an example gNB-to-UE COT sharing in SL-U positioning, according to various arrangements.

FIG. 14 is a diagram illustrating an example of a gNB scheduling different UEs' SL-PRS transmissions within one COT, according to various arrangements.

FIG. 15 is a diagram illustrating an example of UE-to-gNB COT sharing in SL-U positioning, according to various arrangements.

FIG. 16 is a diagram illustrating the relationship between bandwidth of dedicated resource pool and RB sets, according to various arrangements.

FIG. 17 is an example configuration ServingCellConfig, according to various arrangements.

FIG. 18 is a diagram illustrating semi-static channel access, according to various arrangements.

FIG. 19 is a diagram illustrating semi-static channel access for two UEs, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In some arrangements, wireless communications can be performed on carriers, frequency bands, and/or frequency spectrums. Some carriers are licensed carriers as they are licensed by a government or another authoritative entity to a service provider for exclusive use. Some carriers are unlicensed carriers, which are not licensed by any government or authoritative entities for exclusive use. Two or more service providers may operate in an unlicensed carrier. Currently, UEs may communicate directly with each other (e.g., without doing so using a base station) on the licensed carriers. No schemes have been provided for UEs to communicate with each other on unlicensed carriers.

In some arrangements, a licensed carrier refers to a carrier, frequency band, or spectrum that is licensed by a government or an authoritative entity, such as the Federal Communications Commission (FCC) in the United States and the European Telecommunications Standards Institute (ETSI) in Europe, to a service provider for exclusive use. An unlicensed carrier (or shared spectrum) refers to a carrier, frequency band, or spectrum that is not licensed by a government or another authoritative entity. Two or more service providers may operate in the unlicensed carrier.

The arrangements disclosed herein relate to SL positioning, including channel access procedure and channel design, in unlicensed band (shared spectrum). Signaling proceduresfor sidelink positioning are described herein.

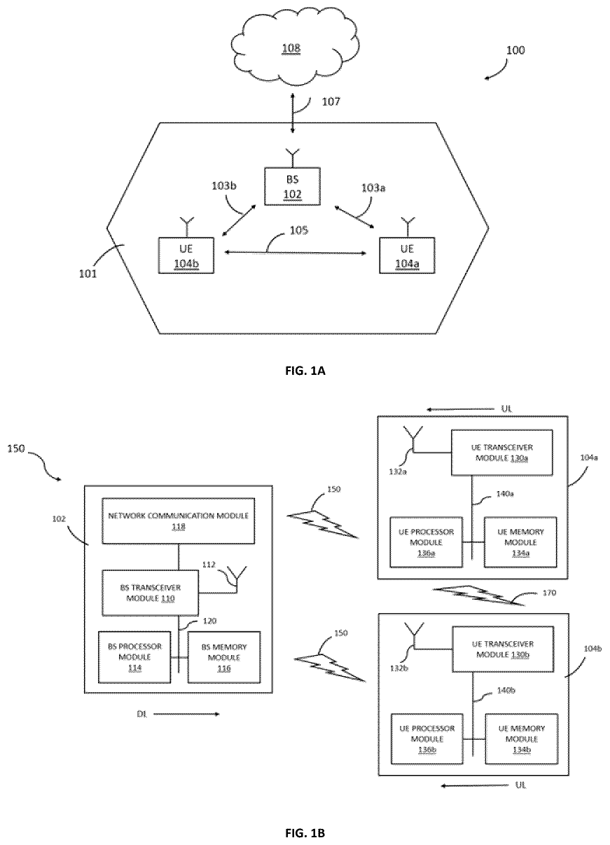

Referring to FIG. 1A, an example wireless communication system 100 is shown. The wireless communication system 100 illustrates a group communication within a cellular network. In a wireless communication system, a network side communication node or a network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In some examples, a UE can be a vehicle UE, a pedestrian UE, a Road-Side UE (RSU), a Positioning Reference Unit (PRU), and so on. A UE described herein can implement the methods described herein with or without a known location. In FIG. 1A, a network side and a terminal side communication node are represented by a network 102 and UEs 104a and 104b, respectively. In some arrangements, the network 102 and UEs 104a/104b are sometimes referred to as “wireless communication node” and “wireless communication device,” respectively. Such communication nodes/devices can perform wireless communications.

In the illustrated arrangement of FIG. 1A, the network 102 can define a cell 101 in which the UEs 104a and 104b are located. The UEs 104a and/or 104b can be moving or remain stationary within a coverage of the cell 101. The UE 104a can communicate with the network 102 via a communication channel 103a. Similarly, the UE 104b can communicate with the network 102 via a communication channel 103b. In addition, the UEs 104a and 104b can communicate with each other via a communication channel 105. The communication channels 103a and 104b between a respective UE and the network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The network 102 is connected to Core Network (CN) 108 through an external interface 107, e.g., an Iu interface.

In some examples, a remote UE (e.g., the UE 104b) that does not directly communicate with the network 102 or the CN 108 (e.g., the communication channel link 103b is not established) communicates indirectly with the network 102 and the CN 108 using the SL communication channel 105 via a relay UE (e.g., the UE 104a), which can directly communicate with the network 102 and the CN 108 or indirectly communicate with the network 102 and the CN 108 via another relay UE that can directly communicate with the network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication system 100 of FIG. 1A, as described above.

The system generally includes the network 102 and UEs 104a and 104b, as described in FIG. 1A. The network 102 includes a network transceiver module 110, a network antenna 112, a network memory module 116, a network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the network 102 is known as an uplink transmission, and a wireless transmission from an antenna of the network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the network transceiver module 110 may be herein referred to as a downlink transceiver, or network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the network 102 that enable bi-directional communication between network transceiver 110 and other network components and communication nodes configured to communication with the network 102. For example, the network interface 118 may be configured to support internet or WiMAX traffic. In a typical deployment, without limitation, the network interface 118 provides an 802.3 Ethernet interface such that network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the network 102 to communicate with other networks or core network over a wired or wireless connection.

In some arrangements, each of the UEs 104a and 104b can operate in a hybrid communication network in which the UE communicates with the network 102, and with other UEs, e.g., between 104a and 104b. As described in further detail below, the UEs 104a and 104b support SL communications with other UE's as well as downlink/uplink communications between the network 102 and the UEs 104a and 104b. In general, the SL communication allows the UEs 104a and 104b to establish a direct communication link with each other, or with other UEs from different cells, without requiring the network 102 to relay data between UEs.

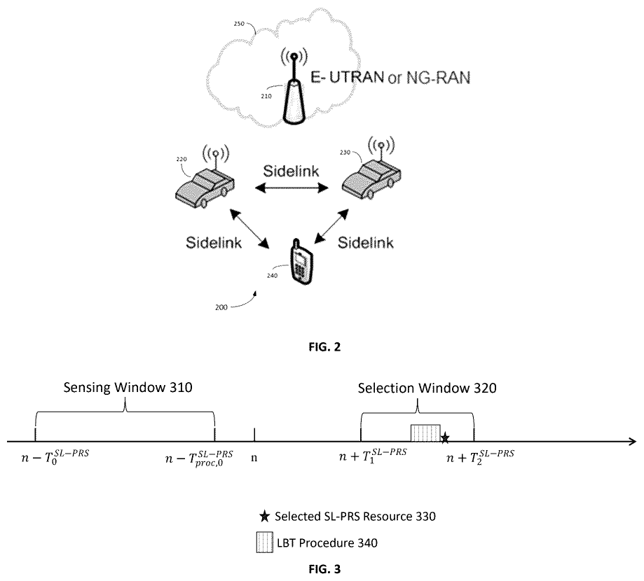

FIG. 2 is a diagram illustrating an example system 200 for SL communication, according to various arrangements. As shown in FIG. 2, a base station 210 (such as network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX or Tx) UE, and the UE that is receiving said data is referred to as the reception (RX or Rx) UE.

In some examples, for SL positioning/ranging in licensed band or ITS band, both scheme 1 resource allocation and scheme 2 resource allocation are supported. Scheme 1 resource allocation can also be seen as network-centric operation and SL-PRS resource allocation in which the SL-PRS resources to be transmitted are configured/scheduled by the BS (e.g., gNB) via either dynamic grant, configured grant type 1, or configured grant type 2. Scheme 2 is a UE autonomous SL-PRS resource allocation mode where SL-PRS resources to be transmitted are based on either/both sensing results, Inter-UE Coordination (IUC) information, or/and random resource selection.

In5G New Radio-Unlicensed (NR-U) or SL-Unlicensed (SL-U), the main restriction of using shared or unlicensed spectrum is that devices including BS, UE, or other non-3GPP users (e.g., WIFI devices) can access to a channel only after a Listen Before Talk (LBT) success or if the Clear Channel Assessment (CCA) results show that the channel is idle. In some cases, a channel access procedure is a procedure based on sensing that evaluates the availability of a channel for performing transmissions.

FR1 NR-U includes two CCA modes. A first CCA mode includes Load-Based Equipment (LBE) or a dynamic channel access mode. For either Downlink (DL) channel access and/or Uplink (UL) channel access, Type 1 includes CCA time before a transmission is random, and Type 2 includes CCA time before a transmission is deterministic. Type 2 further includes Type 2A, Type 2B, and Type 2C. There are differences between DL channel access and UL channel access, e.g., the Channel Access Priority Class (CAPC) tables for DL type 1 channel access and type 1 UL channel access are different.

A second CCA mode includes Frame-Based Equipment (FBE) or semi-static channel access mode, in which the time-domain resources for FBE mode is periodic. One Fixed Frame Period (FFP) includes a Channel Occupancy Time (COT) and idle period. The idle period is located at the end of an FFP.

In some arrangements a UE performs a channel access scheme referred to as LBT before performing data transmission on an unlicensed carrier. In the LBT procedure, the UE monitorsa channel in the unlicensed carrier for an interval of time. In response to determining that the LBT procedure is successful, the UE can occupy the channel in the unlicensed carrier for an interval of timereferred to as COT. The LBT procedure includes initial LBT procedure and non-initial LBT procedure. The non-initial LBT procedure is performed within the COT.

In some arrangements, the CAPC table described herein is used for Type 1 channel access. For example, the CAPC table defines the association relationship between CAPC (p) and {mₚ, CW_{min, p}, CW_{max, p}, T_{m cot, p}, allowed CWₚ sizes}. In some examples, mₚ refers to the defer duration T_{d} which includes duration T_{f}=16 μs immediately followed by mₚ consecutive sensing slot durations Tₛₗ. T_{f} includes an idle sensing slot duration Tₛₗ at start of T_{f}. For CW_{min, p}, CW_{max, p}, allowed CWₚ sizes, CWₚ is the size of the Contention Window (CW), where CW_{min, p}≤CWₚ≤CW_{max, p}. CWₚ adjustment is supported for DL/UL channel access and SL channel access for communication based on the allowed CWₚ sizes associated with a CAPC p. With respect to T_{m cot, p}, a UE or BS (e.g., eNB or gNB)does not transmit on a channel for a COT that exceeds T_{m cot, p} where the channel access procedures are performed based on a CAPCp associated with the transmissions of the UE or BS.

A channel in NR-U or SL-U refers to a carrier or a part of a carrier including a contiguous set of frequency-domain resources (e.g., Resource Blocks (RBs)) on which a channel access procedure is performed in a shared spectrum. In some examples, one channel is associated with one RB set. In the examples in which the service requests wide bandwidth (e.g., including two or more RB sets), the device applies the multi-channel access procedure. DL type A and type B multi-channel access procedure and UL multi-channel access procedures can be implemented.

In some arrangements, an RB set is configured in parameter ServingCellConfig for DL/UL channel access via defining the length and location of guard bands (zero-size guard band is also allowed).

For SL-U positioning, a UE can transmit Physical Shared Control Channel (PSCCH) and its corresponding SL PRS in a shared spectrum. An initiating UE refers to a UE that initiates a channel access procedure and occupy a COT. The initiating UE is expected to transmit SL positioning-related data in this COT. From initiating UE's perspective, the initiating UE performs channel access procedure based on sensing/LBT that evaluates the availability of a channel for SL positioning-related transmission. The COT occupied by the initiating UE can be shared to other UE(s) for other UE(s)'s SL positioning transmission purpose.

Both dynamic channel access and semi-static channel access can be supported for SL positioning in shared spectrum. From the initiating UE's perspective, dynamic channel access procedure is performed by a UE where the time duration spanned by the sensing slots that are sensed to be idle before a SL transmission is random or fixed based on dynamic SL positioning transmission demands. For semi-persistent channel access, the opportunity of COT is periodic.

For SL positioning/ranging in unlicensed band, a UE cannot directly transmit SL-PRS resources based on either network's configuration/scheduling or UE's autonomous resource selection (sensing, IUC, random resource selection) without LBT procedure. FIG. 3 is a schematic diagram illustrating candidate resource selection for transmitting SL-PRS, according to various arrangements. In scheme 2, a UE first selects candidate resources within a selection window 320 based on sensing results performed within the sensing window 310. The UE can transmit the selected SL-PRS resource(s) 330 only within a COT. In other words, a selected or configured SL-PRS resource cannot be transmitted without success of the LBT procedure 340. Either this UE initiates a COT or shares a COT with other UEs or a BS.

The basic unit for sensing is a sensing slot with a duration Tₛₗ=9 μs. The sensing slot duration Tₛₗ is considered to be idle if a UE senses the channel during the sensing slot durationand determines that the detected power for at least 4 μs within the sensing slot duration is less than energy detection threshold X_{Thresh}. Otherwise, the sensing slot duration Tₛₗ is considered to be busy. The arrangements disclosed herein use a LBT time duration or CCA time to represent the time duration spanned by the sensing slots that are sensed to be idle before a SL transmission.

The COT refers to the total time for which UE and any UE(s)/BS sharing the channel occupancy perform transmission(s) on a channel after a UE performs the corresponding channel access procedures. For determining the COT, if a transmission gap is less than or equal to 25 μs, the gap duration is counted in the COT.

A SL transmission burst for SL positioning is defined as a set of SL transmissions for SL positioning (e.g. SL-PRS transmission) from a UE without any gaps greater than 16 μs. Transmissions from a UE separated by a gap of more than 16 μs are considered as separate SL transmission bursts. A UE can transmit SL transmission(s) after a gap of up to 16 μs within a SL transmission burst without sensing the corresponding channel(s) for availability.

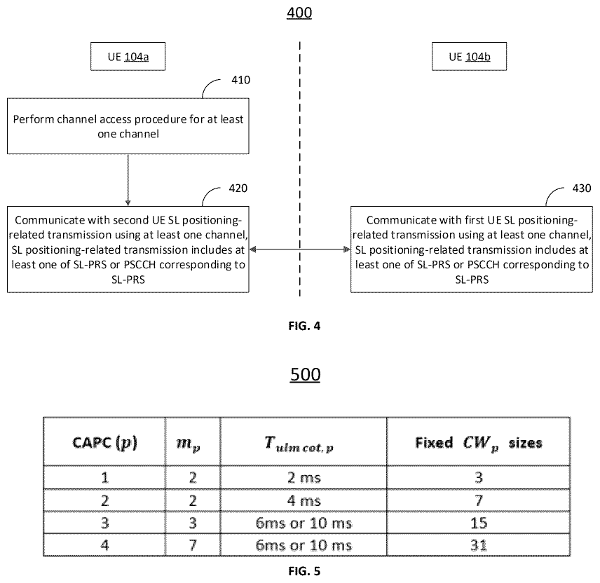

FIG. 4 is a flowchart diagram illustrating an example method 400 for communicating SL positioning-related transmission, according to various arrangements. The method 400 can be performed using the system 100.

At 410, a first UE (e.g., the UE 104a) performs a channel access procedure for at least one channel. In some examples, the first UE performs the channel access procedure before its transmission (e.g., at 420). The channel access procedure may or may not be performed with the second UE (e.g., the UE 104b).

The first UE may transmit a SL positioning-related transmission after a channel access procedure, the SL positioning-related transmission is intended to be sent tothe second UE or multiple UEs (including the second UE) based on the cast type. For example, at 420, the first UE communicates with (e.g., sends or transmits to) the second UE SL positioning-related transmission using the at least one channel. The SL positioning-related transmission includes at least one of an SL-PRS or a PSCCH corresponding to the SL PRS. At 430, the second UE communicates with (e.g., receives from) the first UE theSL positioning-related transmission using the at least one channel.

In some arrangements, for SL positioning in a shared or unlicensed spectrum, the UE can perform Type 1 channel access procedure in which the time duration (spanned by the sensing slots that are sensed to be idle before a SL transmission) is random. The UE can transmit a SL positioning-related transmission after first sensing the channel to be idle during the sensing slot durations of a defer duration T_{d} and after the counter N is zero. The counter N is adjusted by sensing the channel for additional sensing slot duration(s). For example, the UE can 1) set N=Nᵢₙᵢₜ, where Nᵢₙᵢₜ is a random number uniformly distributed between 0 and CWₚ, and go to step 4;2)if N>0 and the UE chooses to decrement the counter, set N=N−1; 3) sense the channel for an additional sensing slot duration, and if the additional sensing slot duration is idle, go to step 4; else, go to step 5; 4) if N=0, stop; else, go to step 2; 5) sense the channel until either a busy sensing slot is detected within an additional defer duration T_{d} or all the sensing slots of the additional defer duration T_{d} are detected to be idle; 6) if the channel is sensed to be idle during all the sensing slot durations of the additional defer duration T_{d}, go to step 4; else, go to step 5.

In some arrangements, in response to determining thatthe UE has not transmitted a SL transmission after step 4 in the procedure above, the UE can transmit a transmission on the channel, if the channel is sensed to be idle at least in a sensing slot duration Tₛₗ when the UE is ready to transmit and if the channel has been sensed to be idle during all the sensing slot durations of a defer duration T_{d} immediately before this transmission. If the channel has not been sensed to be idle in a sensing slot duration Tₛₗ when the UE first senses the channel after it is ready to transmit or if the channel has been sensed to be not idle during any of the sensing slot durations of a defer duration T_{d} immediately before this intended transmission, the UE proceeds to step 1 after sensing the channel to be idle during the sensing slot durations of a defer duration T_{d}.

In some arrangements, the UE does not transmit on a channel for a COT that exceeds the maximum COT (T_{mcot, p}_{_{CAPC}}). The LBT time duration and maximum COT is associated with a CAPC according the CAPC table for SL-U positioning. In some arrangements, theCAPC table for SL-U positioning reuses the CAPC table for DL. In some arrangements, the CAPC table for SL-U positioning reuses the CAPC table for UL. In some arrangements, the CAPC table for SL-U positioning reuses the CAPC table for SL communication.

In some arrangements, based on either CAPC table for DL, CAPC table for UL or CAPC table for SL communication, the CAPC table can be updated based on SL-PRS configuration. In some arrangements, one or more additional row in CAPC table for SL positioning can be introduced. For example, at least one additional candidate maximum COT can be introduced, before example, in addition to the candidate maximum COT ranges from 2 ms to 10 ms in legacy NR-U in FR2. In order to increase the probability of successful channel access, a lower maximum COT (e.g., T_{mcot, p}_{_{CAPC}}=1 ms) can be introduced such that a UE can use less LBT duration to access one or more channel(s). In some examples, the maximum COT is less than 2 ms in SL-U positioning. In some example, the maximum COT can be within a range of X ms-2 ms, where X is a slot length or determined based on the slot length. For example, X is 1 ms in 15 kHz, and 0.5 ms in 30 kHz. In some arrangements, based on either CAPC table for DL, CAPC table for UL, or CAPC table for SL communications, the configuration of CWof SL positioning CAPC table can be changed.

In some arrangements, CAPC of SL positioning can be determined by the UE. The manner in which the CAPC is determinedis applicable for either a dedicated resource pool or shared resource pool for SL positioning.

In some arrangements, CAPC of SL-U positioning is associated with SL-PRS configurations/characteristics. In some arrangements, the channel access procedure includes a Type 1 channel access for determining SL positioning of the first UE in an unlicensed band. A CAPC used in the Type 1 channel access of the SL positioning of the first wireless communication device corresponds to a LBT time duration and a maximum COT. The CAPC corresponds to a configuration or a characteristic of the SL PRS.

In some arrangements, the CAPC value or CAPC index is explicitly indicated, configured, or preconfigured. Accordingly, the CAPC value or CAPC index can be explicitly indicated, configured, or pre-configured as one of SL-PRS configurations/characteristics. In some arrangements, the method 400 further includes receiving, by the first UE, an indication, a configuration, or a pre-configuration of a CAPC value or a CAPC index corresponding to the CAPC as the configuration or the characteristic of the SL PRS.

In some arrangements, a CAPC value can be either configured or pre-configured per resource pool, per SL-PRS resource set, or per SL-PRS resource. For example, the BS can deliver/configure CAPC information to UE. CAPC value can be either configured or pre-configured per resource pool, per SL-PRS resource set or per SL-PRS resource in Radio Resource Control (RRC) signaling. In some examples, in scheme 1 resource allocation, a BS can include CAPC information in Downlink Control Information (DCI) or via configured grant SL-PRS transmission, or via Medium Access Control (MAC) Control Element (CE). In some arrangements, at least one of the CAPC value is configured or pre-configured for each resource pool, or for each SL-PRS resource set, or for each SL-PRS resource.

In some examples in which CAPC value is configured per SL-PRS resource pool, a UE transmits SL-PRS in this slot shall obey the Type 1 channel access rule according to the only CAPC. In some examples in which the CAPC value is configured per SL-PRS resource set, different SL-PRS resource set may have the same or different CAPC values. In some examples in which CAPC value is configured per SL-PRS resource, different SL-PRS resource may have the same or different CAPC values.

In some arrangements, the UE 104a may receive the CAPC information from another UE. Sidelink Positioning Protocol (SLPP) or PC5-RRC or SL MAC CE or Sidelink Control Information (SCI) can be used as the container of CAPC information. CAPC value can be either configured or pre-configured per resource pool, per SL-PRS resource set or per SL-PRS resource.

In some arrangements, the LMF can deliver or configure or recommend CAPC information to the UE 104a via Long Term Evolution Positioning Protocol (LPP) signaling. CAPC value can be either configured or pre-configured per resource pool, per SL-PRS resource set or per SL-PRS resource. In some examples, the UE receives its CAPC value from LMF using a procedure that includes: (1) the BS 102 first sends the CAPC and associated SL-PRS configuration to the LMF via NRPPa; (2) LMF collects information from multiple BSs; (3) based on the service type and need, LMF may request BSs to adjust CAPC values for certain SL-PRS resources via NRPPa; (4) the BS 102 adjusts the CAPC values and sends the updated configuration to the LMF via NRPPa; (5) the LMF distribute the collected information to UE via LPP, or the LMF adjusts CAPC values for certain SL-PRS resources and distribute the collected information to the UE 104a. The higher layer of the UE 104a determines the CAPC value or the CAPC index.

In some arrangements, the CAPC is received by the first UE (e.g., the UE 104a) from the BS 102 via at least one of RRC signaling, a DCI, or a MAC CE. In some arrangements, the CAPC is received by the first UE from the second UE (e.g., the UE 104b) or a third UE via at least one of SLPP signaling, PC5-RRC signaling, SL MAC CE, or SCI. The third UE can be any UE different from the first and second UEs, and can be referred to as a server UE. The server UE can be used for positioning method determination, anchor UE selection, assistance distribution and/or location calculation in resource allocation scheme 2. The server UE can be used to deliver CAPC config to the Tx UE. In some examples, either the anchor UE or target UE or any UEs can be the server UE. In some arrangements, the CAPC is received by the first UE from an LMF via LPP.

In some arrangements, the CAPC value or CAPC index is not explicitly indicated as part of SL-PRS configurations/characteristics. In other words, each CAPC is associated with one or more SL-PRS configuration/characteristic(s). Based on SL-PRS configuration/characteristic, the corresponding CAPC is known and thus saving signaling overhead. In some arrangements, the method 400 further includes determining, by the first UE, the CAPC value or the CAPC index using a mapping between: CAPC values or CAPC indices andthe configuration or the characteristic of the SL PRS.

In some arrangements, the configuration or the characteristic of the SL PRS comprises SL PRS priority levels, which are associated with CAPC information. For example, the CW size (e.g., minimum, maximum, allowed) and maximum COT duration of SL-PRS CAPC table are related or mapped to SL-PRS priority. In an example in which there are 8 SL-PRS prioritylevels: {0,1,2,3,4,5,6,7} and 4 CAPC values for SL positioning, there is a mapping relationship between SL-PRS priority levelsand the 4 CAPC values. For example, SL-PRS priority {0,1} is associated with CAPC{1}, SL-PRS priority {2,3} is associated with CAPC{2}, SL-PRS priority {4,5} is associated with CAPC{3}, SL-PRS priority {6,7} is associated with CAPC{4}.

Implicitly indicating CAPC value conserves signaling-overhead, given that all the devices in SL-U may use the same association relationships between CAPC and SL-PRS priority.

In some examples, the SL-PRS's time-domain resource duration is associated with COT value in CAPC table. Based on SL-PRS's time-domain configuration (e.g., periodicity, repetition factor, time gap, number of symbols of a slot, the number of consecutive slots/symbols a UE is intended to transmit), one or more COT(s) candidate value is known to be feasible. In the example in which a UE's consecutive SL-PRS transmission is 3 ms, the COT value required is at least 3 ms. The maximum COT of SL-PRS CAPC table is related or mapped to the duration of SL-PRS transmission. Thus, in some arrangements, the configuration or the characteristic of the SL PRS includes a time-domain resource duration corresponding to a COT value in a CAPC table. Configuration for the time-domain resource duration includes at least one of a periodicity, a number of symbols of a slot, a repetition factor, a time gap, a number of consecutive slots/symbols that the first UE is to transmit.

In some arrangements, CAPC of SL positioning and SL-PRS configurations/characteristics are independent.

In some arrangements, the CAPC information (e.g., CAPC value or CAPC index) of SL positioning is explicitly indicated/configured or pre-configured, it is up to higher layer configuration.

In some examples, the BS 102 can deliver or configure CAPC information to the UE 104a. For example, CAPC value can be configured or pre-configured per resource pool. In some examples, in scheme 1 resource allocation, BS 102 can include CAPC information in DCI or via configured grant SL-PRS transmission to be sent to the UE 104a. In the examples in which the CAPC value is configured per SL-PRS resource pool, the UE 104a transmits SL-PRS in this slot using the Type 1 channel access rule according to the only CAPC. In some examples, the UE 104a may receive the CAPC information from another UE. SLPP or PC5-RRC or SL MAC CE or SCI can be used as the container of CAPC information. In some arrangements, the method 400 further includes receiving, by the first UE, a CAPC of the SL positioning of the first wireless communication device. In some examples, the CAPC is received by the first UE from the BS 102 via at least one of RRC signaling, a DCI, or a MAC CE. In some examples, the CAPC is received by the first UE from the UE or a third UE via at least one of SLPP signaling, PC5-RRC signaling, SL MAC CE, or SCI. In some examples, the CAPC is received by the first UE from an LMF via LPP.

In some examples, the LMF can deliver or configure CAPC information to UE via LPP signaling. The UE receives its CAPC value from LMF using a procedure that includes: (1) the BS 102 first sends the CAPC and associated SL-PRS configuration to LMF via NRPPa; (2) LMF collects information from multiple BSs; (3) based on the service type and need, LMF may request BSs to adjust CAPC values via NRPPa; (4) the BS 102 adjusts the CAPC values and sends the updated configuration to LMF via NRPPa; (5) the LMF distribute the collected information to the UE 104a via LPP, or LMF adjusts CAPC values for certain SL-PRS resources and distribute the collected information to the UE 104a.

In some arrangements, the first UE receives the CAPC from the LMF. In some examples, the BS sends the CAPC and SL-PRS configuration corresponding to the CAPC to the LMF via a first NRPPa signaling. The LMF receives information from a plurality of BSs and requests the plurality of BSs to adjust CAPC values via a second NRPPa signaling. The plurality of BSs adjust the CAPC values and send adjusted configuration corresponding to the adjusted CAPC values to the LMF via a third NRPPa signaling. The LMF distributes the adjusted configuration to the UE via LPP signaling.

In some arrangements, the UE, on its own, determines the CAPC information of SL positioning, where there is no configuration/indication of the network, e.g., no DCI is received by the UE 104a.

In some examples, the method 400 further includes determining, by the first UE, a CAPC value for the SL positioning-related transmission using CAPC values contained in at least one of MAC CE, Common Control Channel (CCCH) Service Data Unit (SDU), Dedicated Control Channel (DCCH) SDU, MAC SDUs, or SL Shared Channel (SL-SCH) subheader. In the examples in which CAPC is not configured/indicated, the UE 104a selects the CAPC not only based on priority CAPC of those MAC CEs, CCCH SDUs, DCCH SDUs, MAC SDUs, but also based on priority CAPC of SL-SCH subheader (SL-SCH subheader includes L2 source/destination ID). In some examples, in response to determining that only MAC subheader and SL-SCH subheader are included in the TB, the highest priority CAPC is used. For example, in shared resource pool, SL-PRS, associated PSCCH and PSSCH scheduled by the PSCCH are included in the same slot. The PSSCH can used for the second stage SCI and SL-SCH. The UE 104a may not have data available for transmission, a MAC PDU (SL-SCH) including one SL-SCH subheader and one or more MAC subPDUs. Each MAC subPDU may include a MAC subheader only or a MAC sub-header and padding.

In the examples in which only MAC subheader and SL-SCH subheader are included in the TB, the lowest priority CAPC is used. In the examples in which only MAC subheader and SL-SCH subheader are included in the TB, the highest priority CAPC is used. In the examples in which only MAC subheader and SL-SCH subheader are included in the TB, the lowest priority CAPC is used. In the examples in which only SL-SCH subheader and MAC CE(s) are included in the TB, the highest priority CAPC of those MAC CE(s) is used. In the examples in which only SL-SCH subheader and MAC CE(s) are included in the TB, the highest priority CAPC of those MAC CE(s) and the SL-SCH subheader is used. In the examples in which only SL-SCH subheader and MAC SDU are in the TB, the lowest priority CAPC is used.

Some arrangements relate to determining a proper CAPC value when multiple SL-PRS resources that are intended for transmission are associated with different priority values. Some arrangements relate to determining a proper CAPC value when a UE intends to transmit both SL-PRS and SL-data that are associated with different priority value. Some arrangements relate to performing LBT for multiple consecutive SL transmissions in a potential COT that are associated with different priority values. Some arrangements relate to determining a final priority. Some arrangements relate to determining a COT in the examples in which multiple services are requested.

The UE 104a can initiate the channel occupancy using the SL-PRS CAPC value and transmit SL-PRS accordingly. In the example in which the SL-PRS CAPC value corresponding to SL-PRS transmission is greater than or equal to the CAPC value corresponding to SL data transmission, the UE 104a can directly continue to transmit SL data from the beginning of SL data transmission. The total of transmission duration of SL-PRS transmission and SL data transmission does not exceed the maximum COT corresponding to the SL-PRS CAPC value. In the example in which the SL-PRS CPAC value corresponding to SL-PRS transmission is smaller than the CAPC value corresponding to SL data transmission, the UE 104a can terminate the SL-PRS transmission by dropping the transmission and attempt to transmit the SL-data according to the corresponding CAPC. In some examples, the UE 104a can also continue SL-PRS transmission and ignore the SL data transmission.

In some examples, the UE 104a can initiate the channel occupancy using the SL data CAPC value and transmit SL data accordingly. In the example in which the SL data CAPC value corresponding to SL data transmission is larger than or equal to the CAPC value corresponding to SL-PRS transmission, the UE 104a can directly transmit SL-PRS from the beginning of SL-PRS transmission. The total of transmission duration of SL-PRS transmission and SL data transmission does not exceed the maximum COT corresponding to the SL data CAPC value. In the example in which the SL data CPAC value corresponding to SL data transmission is less than the CAPC value corresponding to SL-PRS transmission, the UE 104a can terminate the SL data transmission by dropping the transmission and attempt to transmit the SL-PRS according to the corresponding CAPC.

In some arrangements, the UE 104a can determine a unified CAPC value to initiate a channel occupancy for more than one SL transmissions (e.g., SL-PRS transmission, SL data transmission). In some arrangements, the method 400 further includes initiating, by the first UE (e.g., the UE 104a), channel occupancy for two or more SL transmissions by determining unified CAPC value. The SL transmissions include at least one of the SL-PRS or a SL data transmission.

In some examples, the unified CAPC can be the highest priority CAPC of those SL transmissions, orthe unified CAPC can be the lowest priority CAPC of those SL transmissions. In some examples, the UE can determine a unified CAPC value to initiate a channel occupancy for SL-PRS transmission and SL data transmission. The unified CAPC value is related or mapped to SL-PRS transmission duration and SL data transmission duration. The maximum COT corresponding to the unified CAPC value is greater than or equal to the total of transmission duration of SL-PRS transmission and SL data transmission. The channel occupancy is initiated at the beginning of SL-PRS transmission using the unified CAPC value and SL-PRS transmission can be transmitted. In some examples, SL-PRS transmission is not over before the beginning of SL data transmission, and the SL-PRS CPAC value corresponding to SL-PRS transmission is greater than or equal to the CAPC value corresponding to SL data transmission, the UE 104a can directly transmit SL data from the beginning of SL data transmission. In some examples, the SL-PRS CPAC value corresponding to SL-PRS transmission is smaller than the CAPC value corresponding to SL data transmission, the UE 104a may terminate the SL-PRS transmission by dropping the transmission and attempt to transmit the SL-data according to the corresponding CAPC. In some examples, the UE 104a may also continue SL-PRS transmission and ignore the SL data transmission.

In some arrangements, CW adjustment mechanism in both NR-U and SL-U can be associated with HARQ-ACK feedback. When the possibility of ACK feedback is higher than a threshold, the UE 104a may assume that current channel condition is reliable and thus relatively shorter LBT duration or a shorter CW is sufficient for CC. Otherwise, a longer LBT duration or a longer CW is needed. In dedicated resource pool for SL positioning, Acknowledgement (ACK)/Negative Acknowledgement (NACK) feedback for SL-PRS or lower-layer feedback-based retransmissions (e.g., in Release 18) is not supported. The arrangements described herein relate to introducing CW adjustment for SL positioning.

In some examples, the CAPC value mentioned can be either the CAPC indicated/configured or a virtual CAPC. If CAPC is explicitly indicated/configured, then the CAPC value is indicated/configured. Otherwise, if there is no CAPC value, a device can assume a virtual CAPC based on SL-PRS configuration/characteristic(s). Some arrangements relate to determining the CW of SL positioning CAPC table. In some arrangements, the method 400 further includesperforming, by the first UE, a CCA for a LBT time duration according to a CW size andaccessing, by the first UE, one or more SL channels for SL positioning with or without adjusting the CW size. In some examples, for type 1 channel access, the actual LBT is random based on both CW size (related to CAPC) and the actual channel assessment situation. For example, if the channel is sensed to be busy, then the UE 104a needs to continue with performing LBT. It is thus difficult for a UE to determine the actual LBT time duration.

In some arrangements, CW adjustment is disabled or canceled for SL-U positioning. FIG. 5 is a CAPC table 500, according to various arrangements. An example is shown in table 500, each CAPC value T_{mcot, P}_{_{CAPC}} is corresponding to one fixed CW sizeCWₚ. There is no need to have 3 columns “CW_{min, p},” “CW_{max, p},” and “allowed CWₚsizes,” and instead only one column “CWₚ” is sufficient.

In some examples, the number of CAPC values is associated with all the configurable CWₚ for SL positioning. For example, if candidate of CWₚ is {3, 7, 15, 31, 63, 127, 255, 511, 1023}, each CWₚ candidate can be associated with one CAPC value where the higher the CAPC value, the higher the CW size. Different CAPC values may have the same or different CW size. In some examples, if each CAPC value still corresponding to two or more allowed CWₚ sizes, for each transmission of SL positioning, the UE 104a randomly selects one candidate CWₚ size without any CW adjustment mechanisms. In some examples, if each CAPC value is associated with two or more allowed CWₚ candidates, the UE 104a can use the CWₚ for channel access as indicated/configured by another UE (via SLPP, PC5-RRC, SL MAC CE, SCI), the LMF (via LPP), or the BS 102 (via RRC, DCI or MAC CE).

In some arrangements, the first UE accesses the one or more SL channels without adjusting the CW size. Each CAPC value is associated with a fixed CW size. Each CAPC value is associated with two or more CW sizes. The first UE randomly selects one candidate CW size from the two or more CW sizes for transmitting a respective SL-PRS. Each CAPC value is associated with two or more CW sizes, the first UE uses a CW size for the channel access procedure as indicated or configured by at least one of the BS 102, the second UE 104b, a third UE, or the LMF.

In some arrangements, CW adjustment is supported in SL-U positioning, the CW size is associated with the channel assessment result. In other words, in case of reliable channel conditions, the CW size CWₚ can be set as a relatively small value. Otherwise, longer time is needed to evaluate the availability of the channel. The method of claim 400, further comprising adjusting, by the first UE, the CW size using a channel assessment result.

In some arrangements, the channel assessment can be associated with SL-PRS Reference Signal Received Power (RSRP) feedback or PSCCH DMRS RSRP of the Rx UE (e.g., the UE 104b). The PSCCH is associated with or corresponding to SL-PRS transmission.

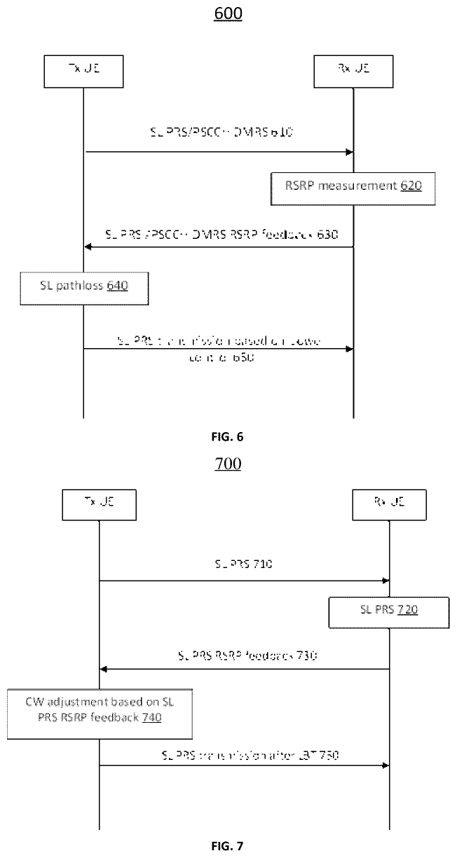

FIG. 6 is a signaling diagram illustrating an example method 600 for determining SL pathloss based on power control, according to various arrangements. In the method 600, the Tx UE can be the UE 104a, and the Rx UE can be the UE 104b. At 610, the Tx UE sends SL PRS/PSCCH DMRS to the Rx UE. At 620, the Rx UE performs RSRP measurements. At 630, the Rx UE sends the SL PRS/PSCCH DMRS RSRP feedback to the Tx UE. At 640, the Tx UE determines the SL pathloss based on the SL PRS/PSCCH DMRS RSRP feedback. At 650, the Tx UE sends the SL PRS transmission based on power control, which is determined based on the SL pathloss 640. The SL pathloss based power control requires the Rx UE to send the SL PRS/PSCCH DMRS RSRP feedback to Tx UE via PC5-RRC. The Rx UE can send the SL positioning related RSRP feedback (e.g., the SL PRS/PSCCH DMRS RSRP) to Tx UE via SLPP, PC5-RRC, SCI, or SL MAC CE. The Tx UE can adjust or maintain the CWₚ by comparing the RSRP feedback and a RSRP threshold.

The RSRP threshold can be configured or pre-configured to UE by another UE, the BS 102, or the LMF via a respective one of the LPP, SLPP, RRC, MAC CE, DCI, SL MAC CE. The RSRP threshold can be configured per UE or per BWP or per SL positioning resource pool or per SL-PRS resource or per SL-PRS resource set. If the received SL-PRS RSRP is higher than a RSRP threshold, the Tx UE can assume the channel is under good condition, and the Tx UE can maintain the CWₚ. Otherwise, Tx UE increase CWₚ for each priority class to the next higher allowed value.

FIG. 7 is a signaling diagram illustrating an example method 700 for adjusting CW based on measurement result feedback, according to various arrangements. In the method 70, the Tx UE can be the UE 104a, and the Rx UE can be the UE 104b. At 710, the Tx UE can send the SL PRS to the Rx UE. The Rx UE at 720 measure the SL PRS. The Rx UE sends the SL PRS RSRP feedback to the Tx UE at 730. At 740, the Tx UE adjusts the CW based on the SL PRS RSRP feedback. At 750, the Tx UE sends the SL PRS transmission to the Rx UE after the LBT. In the method 700, in the latest Type 1 channel access, Tx UE successfully transmit SL-PRS in one or more channel. After the Rx UE receiving SL-PRS, the Rx UE sends the SL-PRS RSRP back to Tx UE. Before Tx UE's next channel access, Tx UE compares the received RSRP with RSRP threshold.

In some arrangements, the method 400 further includes receiving, by the first UE from the second UE, measurement results of the SL-PRS or measurement results of the PSCCH of the second UE via at least one of SLPP signaling, PC5-RRC signaling, SL MAC CE, or SCI. The method 400 further includes adjusting or maintaining, by the first UE, the CW size by comparing the measurement results of the SL-PRS or the measurement results of the PSCCH of the second UE and a measurement threshold.

In some arrangements, the Rx UE does not send the SL-PRS RSRP feedback to Tx UE. Instead, Rx UE can indicate to the Tx UE whether and how to adjust the CWₚ. The indication of CW adjustment can be conveyed by SCI or SLPP or PC5-RRC or SL MAC CE. For example, if SCI is used, the “CW adjustment indicator” can be designed as 2 bits which represents “maintain,” “next higher level,” “next lower level,” and “minimum,” respectively. In some examples, “maintain” means reusing the last update of CW, “next higher level” means increasing the CW for every priority class to the next higher allowed value compared with the last update of CW, “next higher level” means increasing the CW for every priority class to the next higher allowed value compared with the last update of CW, and “minimum” means CW is reset as the minimum value CW_{min, p} allowed for every priority class. In some arrangements, the method 400 further includes receiving, by the first UE from the second UE via at least one of SLPP signaling, PC5-RRC signaling, SL MAC CE, or SCI, an indication indicating whether to adjust the CW size and an adjustment information for adjusting the CW size.

In some arrangements, CW adjustment is supported in SL-U positioning, and each CAPC value or SL-PRS configuration/characteristic (e.g., SL-PRS priority) is associated with one or more CWₚ candidates. In such cases, whether and how to adjust the CW size can be determined by another UE (via SLPP, PC5-RRC, SCI SL MAC CE) or LMF (via LPP) or up to UE's implementation or gNB (via RRC, DCI or MAC CE). In some arrangements, the each CAPC value or a configuration or a characteristic of the SL PRS is mapped to two or more CW sizes. In some examples, the method 400 further includes receiving, by the first UE from the second UE via at least one of SLPP signaling, PC5-RRC signaling, SL MAC CE, or SCI, an indication indicating whether to adjust the CW size and an adjustment information for adjusting the CW size. In some examples, the method 400 further includes determining, by the first UE, whether to adjust the CW size and the adjustment information for adjusting the CW size. In some examples, the method 400 further includes receiving, by the first UE from the BS 102 via at least one of RRC signaling, a DCI, or a MAC CE, an indication indicating whether to adjust the CW size and the adjustment information for adjusting the CW size. In some examples, the method further includes receiving, by the first UE from an LMF via LPP, an indication indicating whether to adjust the CW size and the adjustment information for adjusting the CW size.

In some arrangements, another UE (via SLPP), an LMF (via LPP), the UE's implementation, or the BS 102 (via RRC, DCI or MAC CE) can indicate or determine which CWₚ candidate should be used including whether the latest CWₚ should be reused, whether the CWₚ should be adjusted to the next higher level or to the next lower level, whether CWₚ should be set as the minimum or maximum, or specifically which CWₚ should be used.

In some arrangements, no feedback is available, and for each priority class, set CWₚ=CW_{min, p} or reuse the latest CWₚ used for any SL-PRS transmission on the channel using Type 1 channel access procedure associated with the CAPC p. In some examples, if no feedback is available, and the CWₚ is consecutively used for multiple times X, CWₚ is updated by the first UE. For example, the X can be either preconfigured value or configured by the BS 102 per resource pool or per SL BWP. For example, the CWₚ is consecutively used for multiple times X, CWₚ is updated to the next higher allowed value. For example, the CWₚ is consecutively used for multiple times X, CWₚ is updated to the minimum value allowed for the priority class CW_{min,p}.

In some arrangements, CW adjustment can be realized via CAPC value adjustment. In some examples, the first UE adjusts CAPC value in response to determining that the number of LBT failures is greater than N or in response to detecting consistent SL-PRS LBT failures. In some examples, the first UE adjusts CAPC value depending on whether it's an initial SL-PRS transmission or retransmission. In some examples, the first UE adjusts the CAPC value based on the channel condition. In some examples, the first UE can receive the CAPC adjustment indication from another UE (via SLPP, PC5-RRC, SCI SL MAC CE), LMF (via LPP), or gNB (via RRC, DCI or MAC CE), or the first UE can determine the CAPC adjustment by itself.

In some arrangements, the method 400 further includes adjusting, by the first UE, the CW size by adjusting a CAPC value. In some examples, the method 400 further includes receiving, by the first UE from the second UE via at least one of SLPP signaling, PC5-RRC signaling, SL MAC CE, or SCI, an indication indicating whether to adjust the CAPC value and an adjustment information for adjusting the CAPC value. In some examples, the method 400 further includes determining, by the first UE, whether to adjust the CAPC value and the adjustment information for adjusting the CAPC value. In some examples, the method 400 further includes receiving, by the first UE from the BS 102 via at least one of RRC signaling, a DCI, or a MAC CE, an indication indicating whether to adjust the CAPC value and the adjustment information for adjusting the CAPC value. In some examples, the method 400 further includes receiving, by the first UE from an LMF via LPP, an indication indicating whether to adjust the CAPC value and the adjustment information for adjusting the CAPC value.

In some arrangements, determining whether to adjust the CAPC value and the adjustment information for adjusting the CAPC value is based on one of LBT failure time, initial transmission or retransmission for SL positioning, or channel condition.

In some arrangements, for Type 2 channel access procedure for SL positioning, the time duration spanned by the sensing slots (for LBT) that are sensed to be idle before a SL-PRS transmission or before a PSCCH transmission which is associated with one or more SL-PRS resource(s) is deterministic. In some arrangements, the channel access procedure in the method 400 includes a Type 2 channel access for determining SL positioning of the first UE in an unlicensed band, before the SL positioning-related transmission. The method 400 further includes sensing, by the first UE, a time duration of at least one sensing slot for a LBT is idle before the SL positioning-related transmission. The LBT time duration is deterministic.

In some examples, for Type 2A channel access, when the UE 104a uses Type 2A UL channel access procedures for a SL positioning transmission, the UE 104a can transmit the transmission immediately after sensing the channel to be idle for at least a sensing interval T_{short_sl-p}=25 μs. T_{short_sl-p} includes a duration T_{f}=16 μs immediately followed by one sensing slot. T_{f} includes a sensing slot at start of T_{f}. A channel is considered to be idle for T_{short_sl-p} in response to determining that both sensing slots of T_{short_sl-p} are sensed to be idle.

In some examples, for Type 2B channel access, when the UE 104a uses Type 2B UL channel access procedure for a SL positioning transmission, the UE 104a can transmit the transmission immediately after sensing the channel to be idle within a duration of T_{f}=16 μs. T_{f} includes a sensing slot that occurs within the last 9 μs of T_{f}. A channel is considered to be idle within the duration T_{f} in response to determining that the channel is sensed to be idle for total of at least 5 us with at least 4 us of sensing occurring in the sensing slot.

In some examples, for Type 2C channel access, when the UE 104a uses Type 2C UL channel access procedure for a SL positioning transmission, the UE 104a does not sense the channel before the transmission. The duration of the corresponding SL transmission is at most 584 us. In this case, the LBT gap before this SL transmission is up to 16 us.

Some arrangements relate to Type 2 channel access for SL positioning in non-COT-sharing scenario. For non-COT-sharing scenarios, a UE may transmit a SL positioning related transmission (e.g., SL-PRS transmission) using Type 2 channel access in response to determining that certain condition(s) are met. In some examples, one or more conditions are satisfied in order to use a Type 2 channel access procedure (e.g., Type 2A, Type 2B, or Type 2C).

In some examples, the conditions include the time duration of PSCCH/SL-PRS transmission(s) being at most 1 ms. In some examples, the conditions include the duty cycle of PSCCH/SL-PRS transmission(s) being at most 1/20. In some examples, the conditions include the priority of SL-PRS transmission being higher than a certain bar/threshold. In other words, the priority value of SL-PRS transmission is lower than a threshold. The threshold can be configured by the BS 102, an LMF, or another UE, or based on pre-configuration where all devices involved in SL positioning shall apply the same threshold. In some examples, the condition is associated with SL-PRS configuration/characteristic(s). For example, the periodicity and number of symbols within a slot is related to whether a UE can use type 2 channel access procedure. In some examples, the conditions include the CAPC of SL-PRS transmission being lower than a threshold. The threshold can be configured by the BS 102, an LMF, or another UE, or based on pre-configuration where all devices involved in SL positioning shall apply the same threshold. In some arrangements, the method 400 further includes determining that the first UE (e.g., the UE 104a) can use Type 2 channel access based on at least one of a time duration for the SL positioning-related transmission, a duty cycle, a SL-PRS priority, a CAPC, a periodicity, or a number of symbols within a slot.

In some examples, Type 2 channel access for SL positioning related transmission can be used in COT sharing scenario. FIG. 8 is a diagram illustrating an example Type 2 channel access procedure 800 for SL positioning transmission used in COT sharing scenarios, according to various arrangements. As shown in FIG. 8, a UE (e.g., UE 2, responding UE, or the UE 104a) intends to transmit a SL positioning-related transmission (e.g., SL-PRS transmission) after a SL transmission by another UE (e.g., UE 1, initiating UE) in a shared channel occupancy, the UE (e.g., UE 2) can use Type 2 channel access procedure. UE1 can initiate the COT 810 with a maximum COT duration 820, which includes UE1's SL transmission 830, UE2's SL transmission 850, and LBT gap 840 there between.

In some examples, for the container of UE-to-UE COT sharing for SL positioning and the information contained, the UE-to-UE COT sharing information for SL positioning is expected to be transmitted from initiating UE to one or more responding UE(s). UE2, the responding UE, can transmit its SL-PRS in this shared COT (at 850)in response to determining that some conditions are met, for example, the SL-PRS resources to be transmitted by responding UE is within the shared COT (e.g., 810) and so on. One or more types of information can be included as UE-to-UE COT sharing information for SL positioning.

In some examples, the information included as the UE-to-UE COT sharing information for SL positioning includes the time domain information of the COT. This can include one or more of COT duration, each COT duration can be associated with a starting offset. The COT duration can be the whole, entirety, or total COT duration that the initiating UE occupied, or the COT duration can be the remaining COT duration (in other words, the initiating UE (e.g., UE1) may exclude all its own transmitting resources for either half-duplex reason or avoiding resource collision), or the COT duration indicated includes only part of the total COT. The COT sharing duration can include a slot, multiple slots, or one or more symbol(s), part of a slot, or so on.

In some examples, the information included as the UE-to-UE COT sharing information for SL positioning includes frequency domain information of the COT. This can include either the total RB sets, available RB set(s), or one or more RB set(s) that initiating UE would like to share with responding UE(s).

In some examples, the information included as the UE-to-UE COT sharing information for SL positioning includes a source ID and/or a destination ID. The source and/or destination ID pair can be the same or different from what used in single-stage SCI of dedicated resource pool or second stage SCI of shared resource pool. In some examples, one or a list of source and/or destination ID pair can be included.

In some examples, the UE-to-UE COT sharing information for SL positioning includes a group ID indicating that the COT can be shared in a group of UEs. The group ID may include multiple UE ID information for multiple UEs or only group information for the group of UEs. The group ID is received by UEs from higher layer where the higher layer can either be UE's own higher layer or another UE's higher layer signaling (e.g., SLPP) or from network (e.g., RRC, LPP). For example, an anchor UE can share its initiated COT to other anchor UEs in SL-TDOA positioning. Anchor UEs involved in one SL-TDOA positioning are in a group.

In some examples, the information included as the UE-to-UE COT sharing information for SL positioning includes the CAPC of the initiating UE. This can be a factor of whether responding UE can use this COT, based on both responding UE's CAPC and initiating UE's CAPC. In the examples in which this field is absent, COT initiating UE's SL-PRS transmission priority is needed.

In some examples, the information included as the UE-to-UE COT sharing information for SL positioning includes the SL-PRS transmitting priority of initiating UE.

In some examples, the information included as the UE-to-UE COT sharing information for SL positioning includes an indicator of whether this COT is a common COT. The indicator can be one bit. For example, “0” represents COT sharing is only allowed for those responding UEs which have SL-PRS transmission interactions with initiating UE, and “1” represents that all UEs which receive this COT information can share this COT resource.

In some examples, the information included as the UE-to-UE COT sharing information for SL positioning includes one or a list of COT sharing information for SL positioning. The total COT can be multiple parts/comb where each COT combo is associated with a source and/or destination ID pair. One COT combination can include {part of COT duration, one starting offset, one or more RB set(s)} and one UE pair can represent a source and/or destination pair.

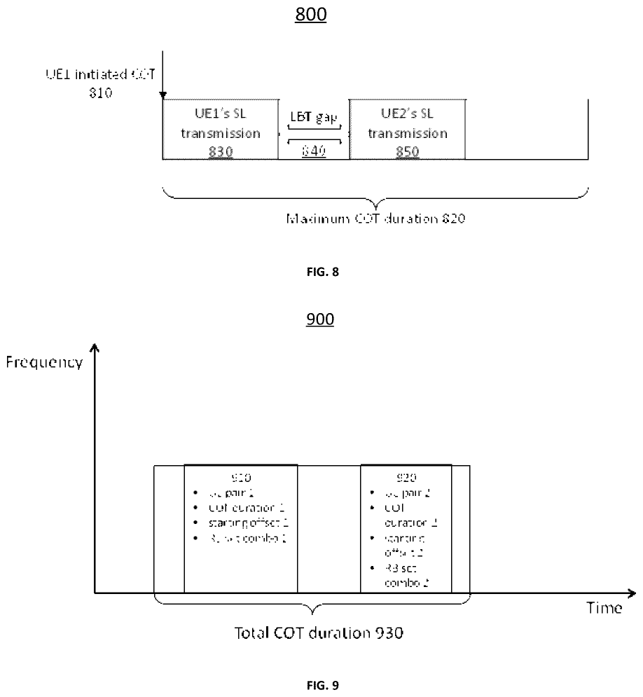

FIG. 9 is a diagram illustrating one COT shared to different responding UEs, according to various arrangements. As shown in FIG. 9, a COT initiating UE may share {UE pair 1, COT duration 1, starting offset 1, RB set(s) 1} in resource 910 with responding UE 1 and share {UE pair 2, COT duration 2, starting offset 2, RB set(s) 2} with responding UE 2 in resource 920. The total COT duration 930 includes the resources 910 and 920. A list of COT sharing information can be conveyed by a single container or each of the COT sharing information comb is conveyed by a single container.

In some examples, the information included as the UE-to-UE COT sharing information for SL positioning includes one COT sharing information for SL positioning and additional source and/or destination ID pair information. In this case, the initiating UE intends to share this COT to multiple responding UEs where each or multiple of which can be associated with one source and/or destination ID pair based on whether SL-PRS is unicast or group cast or broadcast.

In some arrangements, the method 400 further includes receiving, by the first UE from the second UE or a third UE, COT sharing information for the SL positioning, the COT sharing information comprises at least one of time-domain information of a COT, a frequency-domain information of the COT, one or more UE pair information, a CAPC of the first UE, SL-PRS priority of the first wireless communication device, or a common COT indicator, or a group ID. In some examples, the first UE has SL positioning-related transmission to transmit. The second UE or third UE already occupy one or more channel and send the COT sharing information to the first UE. The first UE perform Type 2 channel access and use the COT initiated by the second/third UE to transmit.

In some arrangements, the SCI can be used as the container of UE-to-UE COT sharing for SL positioning. In a dedicated resource pool for SL positioning, different from legacy SL communication design where both first stage SCI and second stage SCI are needed for scheduling and decoding PSSCH. Only single-stage SCI is in dedicated resource pool. In some arrangements, it is possible that the reserved bits in this single-stage SCI is not sufficient for containing UE-to-UE COT sharing information. In some examples, limited reserved bits may be left for single-stage SCI of dedicated resource pool.

In some examples, one UE broadcast COT information is supported where, by default, the frequency domain of COT sharing information is the same as initiating UE's SL-PRS transmitting bandwidth. Only COT duration is contained in such COT sharing container.

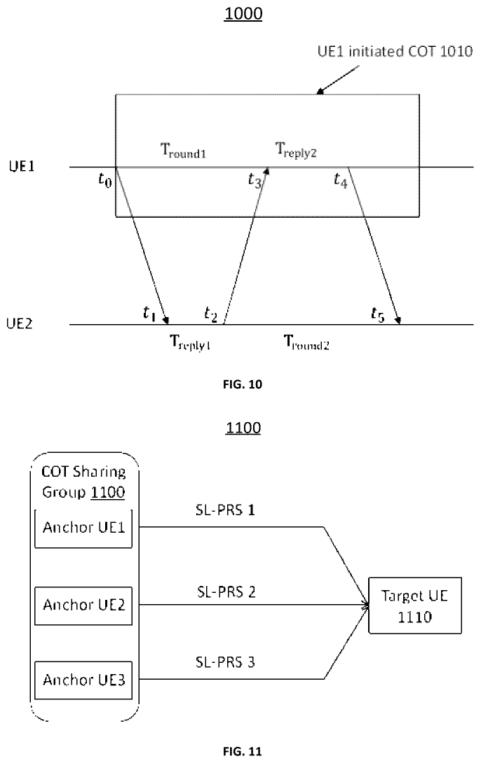

In some examples, the SCI include only 1-bit field for a transmitting permission indicator indicating whether responding UE's reserved resource(s) in this COT can be used for transmission or not. In some examples, for a SL-Round Trip Time (RTT) positioning method, there are round-trip transmissions between two UEs. FIG. 10 is a signaling diagram illustrating an example method 1000 for COT sharing in SL-RTT positioning, according to various arrangements. As shown in FIG. 10, UE1 first transmits a SL-PRS resource to UE 2 at to, which is received by UE2 at t₁. Then UE2 transmits a SL-PRS resource back to UE1 at t₂, which is received by UE1 at t₃. UE1 transmits a SL-PRS resource to UE 2 at t₄, t₀, which is received by UE2 at t₁. In this case, UE1 may first initiate a COT 1010 for transmitting at t₀. Two UEs may know each other's transmission occasions via assistance from server UE or LMF. In response to UE1 determining that UE2 has an intention to transmit at t₂ and t₂ is within its COT 1010, UE1 needs only to inform UE2 whether UE2 can transmit at t₂ or not.

In some examples, a SL-PRS request field is contained in SCI for the triggering of SL-PRS. UE 1 can request UE 2 to transmit SL-PRS. This field can be reused for indicating whether initiating UE is ready to share COT or this field can be reused for transmitting permission indicator. In some examples, the SL-PRS request field and the transmitting permission indicator field can be combined. In some examples, the request SL-PRS transmission and COT are shared (give permission to transmit). In some examples, the SL-PRS transmission is not requested, and COT cannot be shared to responding UE(s).

In some arrangements, the COT sharing information is contained in a SCI. The SCI includes a field indicating whether a reserved SL-PRS resource of the first UE can be used for transmitting the SL-PRS according to whether the reserved SL-PRS resource is within a second UE's initiated COT. Either a new field or an SL-PRS request field in the SCI is used for the indication.

In some arrangements, for a shared resource pool, the SCI is supported for triggering SL-PRS transmission. This field can be reused for indicating whether initiating UE is ready to share COT or this field can be reused for transmitting permission indicator. In some examples, the SL-PRS request field and the transmitting permission indicator field can be combined together. In some examples, request SL-PRS transmission and COT are shared (give permission to transmit). In some examples, the SL-PRS transmission is not requested, and COT cannot be shared to responding UE(s).

In some examples in which SCI is not used as the container of UE-to-UE COT sharing for SL positioning, one of SL MAC CE or SLPP can be used as container. In dedicated SL-PRS resource pool, there is no PSSCH transmitted, and therefore SL MAC CE may not be used. In some arrangements, the COT sharing information is contained in at least one of a MAC CE or SLPP signaling.

In some arrangements, with respect to the relationship between UEs involved in COT sharing (conditions of COT sharing), in SL positioning, the initiating UE can share its COT to one or multiple UEs. COT sharing information can be transmitted using unicast, in which case the initiating UE intends to share its COT with a particular responding UE. In some examples, COT sharing information may be transmitted using group cast. For example, in DL-like SL-Time Difference of Arrival (TDOA) positioning, multiple anchor UEs transmit SL-PRS to target UE respectively. Once one anchor UE successfully occupies one COT, the anchor UE can share this COT to other anchor UEs involved. In some examples, all the anchor UEs involved in one SL-TDOA positioning are in a group. The COT can be shared within one group. Further, COT sharing information can be transmitted using broadcast, where all UEs receiving the SCI containing COT sharing information can perform Type 2 channel access for its SL-PRS transmission.

In some arrangements in which the COT sharing information is transmitted using broadcast, a responding UE can be a UE that satisfies one or more conditions. In some examples, the responding UE can be a receiving UE, which is the target of a SL-PRS transmission of a COT initiating UE. In some examples, the responding UE's SL-PRS transmission within RB set(s) corresponding to a shared COT is intended for the COT initiating UE. In some examples, the responding UE's SL-PRS transmission within RB set(s) corresponding to a shared COT is not intended for the COT initiating UE. In some examples, the responding UE's SL-PRS transmission within RB set(s) corresponding to a shared COT is intended for the same UE as initiating UE's SL-PRS transmission within RB set(s). For example, the responding UE and the initiating UE have the same destination ID.

In some arrangements, with respect to the CAPC/SL-PRS priority value relationships between initiating UE and responding UE in connection with COT sharing, the first UE can perform PSCCH/SL-PRS transmission in response to one or more conditions. For example, a high-priority transmission can share a COT initiated by a low-priority transmission but a low-priority transmission can share a COT initiated by a high-priority transmission. In some examples, the responding UE's SL positioning related transmission(s) within RB set(s) corresponding to a shared COT can be transmitted in response to determining that the CAPC value(s) of the SL transmission(s) have an equal or lesser CAPC value than the CAPC value indicated in the COT sharing information. In some examples, a responding UE's SL positioning related transmission(s) within RB set(s) corresponding to a shared COT can be transmitted in response to determining that the SL-PRS transmission(s) priority have an equal or lesser priority value than the priority value of initiating UE's transmission.

In some examples, there is no need to restrict responding UE's SL-PRS priority or CAPC value. In a sensing-selection procedure, the RSRP threshold of sensing already considers the two UE's SL-PRS transmission priority. In response to determining that CAPC is associated with SL-PRS priority, there is no need to further introduce more restrictions regarding initiating UE and responding UE's CAPC value.

In some arrangements, with respect to whether to support UE-to-UE COT sharing in SL-TDOA positioning, for SL-TDOA scenarios, three cases may be applicable.

In a first case, the anchor UE can share its initiated COT to other anchor UEs in SL-TDOA positioning. In DL-like SL-TDOA positioning, multiple anchor UEs transmit SL-PRS to target UE respectively. Once one anchor UE successfully occupies one COT, that anchor UE can share this COT to other anchor UEs involved. FIG. 11 is a diagram illustrating example COT sharing within a group, according to various arrangements. In some examples, all the anchor UEs (e.g., anchor UE1, UE2, and UE3) involved in one SL-TDOA positioning are in a Cot sharing group 1100. COT can be shared within one UE group. Specifically, LMF, server UE, or the BS 102 can inform the UE group information (e.g., UE ID or source/destination ID) to every anchor UE in the group. Each of the anchor UE1, UE2, and UE3 sends a respective one of SL-PRS 1, SL-PRS 2, and SL-PRS 3 to the target UE 1110.

In some arrangements, the LMF can deliver UE group information for COT sharing to UE via LPP. In some arrangements, the BS 102 can configure UE group information for COT sharing to UE via DCI, RRC, or MAC CE. In some arrangements, a UE (e.g. a server UE) can deliver UE group information for COT sharing to UE via SLPP, SL MAC CE, or SCI.

In some arrangements, only when multiple UEs including initiating UE (e.g., the anchor UEs) transmit SL-PRS to the same UE (e.g. target UE) can initiating UE share its COT to UEs (e.g., the other anchor UEs).

In a second case, the UE-to-UE COT sharing is not supported for SL-TDOA positioning method. In such case, whether UE-to-UE COT sharing can be used is associated with SL positioning method. The use case of UE-to-UE COT sharing may be limited to SL-RTT positioning method.

In a third case, the target UE or another UE (e.g., the server UE) can share its initiated COT to one or more anchor UEs. In a DL-like SL-TDOA positioning method, multiple anchor UEs transmit SL-PRS to the target UE. There is no need for target UE to further transmit SL-PRS to anchor UE. A target UE may initiates a COT but only transmits SCI. The SCI can be seen as a standalone SCI.

In some examples, a server UE can share the initiated COT to one or more anchor UEs. In SL positioning, a server UE can be used to determine positioning method, select anchor UE. distribute assistance data and/or calculate location. Therefore, a server UE may know all the SL-PRS transmission occasions of anchor UEs involved in DL-like SL-TDOA positioning. A server UE can occupy one or more channel(s) with a maximum COT time based on all anchor UEs' SL-PRS transmission occasions and further share this COT with anchor UEs. The server UE may first request anchor UEs for their SL-PRS configurations via SLPP.

In some arrangements, in either dedicated resource pool or shared resource pool, one UE (e.g., UE1) can request another UE's (e.g., UE2's) SL-PRS transmission using at least SCI. In SL-U positioning, even though UE2 receives UE1's request, UE2 may fail to assess the channel due to LBT failure. Some rules can be configured, pre-configured, or set.

In some arrangements, when UE1 sends a SL-PRS request to UE2 for N times and UE1 cannot receive UE2's SL-PRS, UE1 can assume UE2 has trouble in accessing the channel(s), thus UE1 may share its initiated COT with UE2. In some arrangements, when UE1 sends “SL-PRS request” to UE2 but after time T (the unit of T can be ms, slot, symbols, and so on) UE1 still cannot receive UE2's SL-PRS, UE1 can assume UE2 has trouble in accessing the channel(s), thus UE1 may share its initiated COT with UE2. In some arrangements, UE1 sends the SL-PRS request together with COT sharing information to UE2.

Some arrangements relate to IUC based on COT available condition. For IUC scheme 1, a UE (e.g., UE A) can send the preferred or nonpreferred resource set to another UE (UE B) in response to UE A's request or based on UE A's implementation. Moreover, for shared resource pool, both existing IUC scheme 1 and IUC scheme 2 are supported. In some examples, for UE A, whether a SL-PRS resource is preferred or not depends on the collision situation and half duplexing situation. However, considering in SL-U, whether a SL-PRS resource is preferred or not for SL-U IUC can depend on whether this SL-PRS resource is within a COT known by UE A. For example, UE A checks whether this SL-PRS resource is within its initiated COT.

In some arrangements, the CAPC value for the SL positioning transmission of the first UE is equal to or less than a CAPC value that the second UE or third UE use for initiating the COT. In some arrangements, the SL-PRS transmission priority value for the first UE is equal to or less than the SL-PRS transmission priority value that the second UE or third UE use for initiating the COT. In some arrangements, the SL-PRS of the second UE or third UE is transmitted to the first UE. In some arrangements, the SL-PRS of the first UE in the shared COT is transmitted to the second UE or UE. In some arrangements, the SL-PRS of the UE and the SL-PRS of the third UE in the shared COT are transmitted to the same second UE.

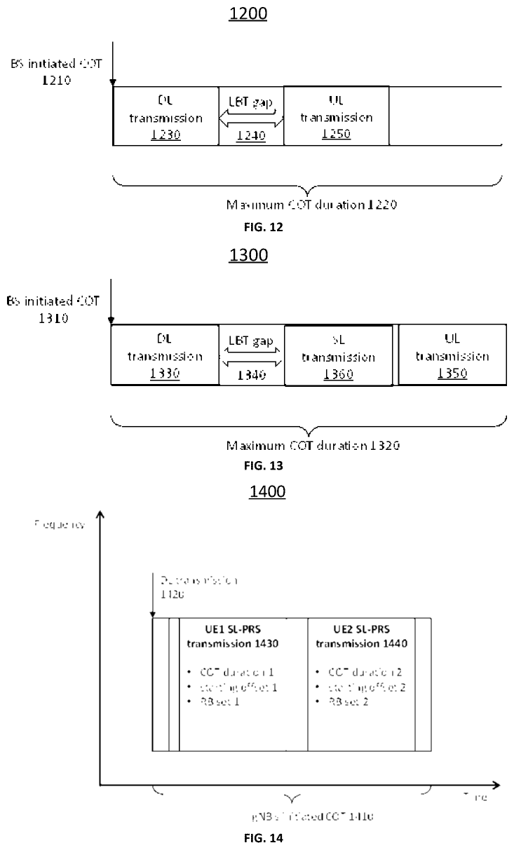

In some arrangements, in NRU channel access, the BS 102 can share its initiated COT to a UE for its UL transmission. FIG. 12 is a diagram illustrating an example gNB-to-UE COT sharing 1200 in NRU, according to various arrangements. As shown in FIG. 12, a UE transmits an UL transmission 1250 in the shared COT 1210 after an LBT gap 1240. The BS (e.g., gNB) initiates the COT 1210. The BS can send the DL transmission 1230 to the UE within the COT 1210. The COT has a maximum curation 1220, which includes the DL transmission 1230, the LBT gap 1240, and the UL transmission 1250.

FIG. 13 is a diagram illustrating an example gNB-to-UE COT sharing 1300 in SL-U positioning, according to various arrangements. As shown in FIG. 13, a UE transmits an UL transmission 1350 in the shared COT 1310 after an LBT gap 1340 and the SL transmission 1360. The BS (e.g., gNB) initiates the COT 1310. The BS can send the DL transmission 1330 to the UE within the COT 1310. The COT has a maximum curation 1320, which includes the DL transmission 1330, the LBT gap 1340, the SL transmission 1360, and the UL transmission 1350.In SL-U positioning, theBS can share its initiated COT 1310 to a UE for its SL transmission 1360. In some examples, this SL transmission 1360 can be a SL-PRS transmission scheduled or configured by the BS 102 in resource allocation scheme 1 via dynamic grant or configured grant.

In some arrangements, the BS 102 initiates a COT and shares the COT with the first UE for the SL positioning-related transmission. The SL positioning-related transmission is scheduled or configured by the BS. In some arrangements, with respect to the container of gNB-to-UE COT sharing for SL positioning, the DCI or MAC CE or RRC can be used for delivering gNB-to-UE COT information for SL positioning purpose in SL positioning resource allocation scheme 1. One or more types of information is carried (for both scheduling purpose and COT sharing purpose). In some examples, the information includes an SL transmission indicator carried in DCI, MAC CE, or RRC. The SL transmission indicator indicates include whether this COT can be used for SL-PRS transmission. If not, this COT can only be shared for UE's UL transmission to the BS 102.

In some examples, the information includes a frequency domain resource such asavailable RB set(s) or total RB set(s) or partial RB set(s). In some examples, the information includes a time domain resource such as an available COT duration or total COT duration or partial COT duration. In some examples, the information includes a feedback indicator indicating whether feedback is needed. The UE may need to transmit feedback information to BS via PUCCH to indicate whether one SL-PRS resource is successfully transmitted.

In some examples, the information includes a channel access type such as type 1 channel access, type 2A channel access, type 2B channel access, type 2C channel access, and so on. In some examples, the information includes the CAPC. For example, if type 1 channel access is indicated, the CAPC value is intended for UE performing Type 1 LBT for SL-PRS transmission. If type 2 channel access is indicated, the CAPC is what the BS uses for performing Type 1 LBT for DL transmission. In some examples, the information includes the CP extension length related indication. In some examples, there is no need to have the restriction that the UE have to transmit data/RS to the BS.

In some arrangements, the BS shares the COT with the first UE using at least one of RRC signaling, a DCI, or a MAC CE. The information for sharing the COT includes at least one of an indicator indicating whether the COT is used for SL positioning related transmission, a frequency domain of the COT, a time domain of the COT, a PUCCH feedback-related indication, a channel access type or CAPC, or a CP extension length related indication. In some arrangements, the first wireless communication device shares its COT after channel access success with a base station (BS) for DL transmission via uplink control information (UCI).

In some arrangements, the DCI can either be the group-common DCI (e.g., DCI format 2-0) for COT sharing or the SL positioning scheduling DCI (e.g., DCI format 3-0) or a new DCI format introduced for SL-U positioning. FIG. 14 is a diagram illustrating an example of a gNB scheduling different UEs' SL-PRS transmissions 1430 and 1440 within one COT 1410, according to various arrangements. As shown in FIG. 14, the BS 102 (e.g., the gNB) can schedule different UEs' SL-PRS transmissions 1430 and 1440 within one COT 1410 without any conflict caused by any wireless communication devices. The BS 102 can initiate the COT 1410, in which the BS 102 can send a downlink transmission 1420 to a UE. Thereafter and within the same COT 1410, the BS 102 schedules the SL-PRS transmission 1430 for UE1 and schedules the SL-PRS transmission 1440 for UE2. The SL-PRS transmission 1430 is defined by COT duration 1, starting offset 1, and RB set 1. The SL-PRS transmission 1440 is defined by COT duration 2, starting offset 2, and RB set 2.

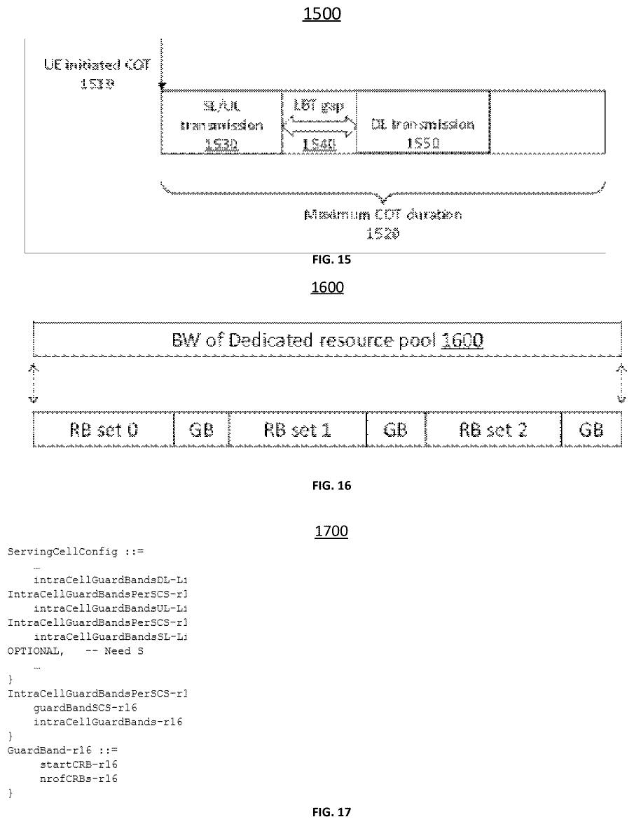

FIG. 15 is a diagram illustrating an example of UE-to-gNB COT sharing 1500 in SL-U positioning, according to various arrangements. As shown in FIG. 15, a UE transmits an SL/UL transmission 1530 in the UE-initiated COT 1510 before an LBT gap 1540 and receives a DL transmission 1550 after the LBT gap 1540. The UE initiates the COT 1510. The is, the UE can share its initiated COT for SL positioning transmission to BS 102 (e.g., gNB) via UCI. The BS 102 can further use this UE initiated COT for DL transmission 1550. The COT 1510 has a maximum curation 1520 which includes the SL/UL transmission 1530, the LBT gap 1540, and the DL transmission 1550.

In some arrangements, in R16 NRU, the basic channel is associated with an RB set. For a wideband transmission, a BS or a UE needs to follow multi-channel access procedure to access multiple channels or multiple RB sets. In SL positioning, for dedicated resource pool, SL-PRS bandwidth is the same as resource pool is supported. SL PRS resource pool and related SL-PRS resources are contained within a single SL BWP and carrier. FIG. 16 is a diagram illustrating the relationship between bandwidth of dedicated resource pool and RB sets, according to various arrangements. As shown in FIG. 16, one dedicated resource pool 1600 can be configured to include at least integer number of RB sets, e.g., RB set 0, RB set 1, RB set 2, and so on. In the example in which the transmission bandwidth of SL-PRS is the same as bandwidth of dedicated resource pool, a UE need to access to multiple channels (multiple RB sets, 3 RB sets shown in FIG. 16) for transmitting SL-PRS among multiple RB sets. The RB sets are separated by Guard Bands (GBs).

In some arrangements, the location and number of RB set(s) and GB(s) are configured in the IE ServingCellConfig. The location and number of RB set(s) and GB(s) for SL positioning transmission can be configured different from that for UL or DL transmission by BS via RRC signaling. For example, an IE “intraCellGuardBandsSL-List” can be added in ServingCellConfig as shown in FIG. 17.

Regarding multi-channel access for SL positioning, one or more procedure/type(s) should be applied before a UE transmitting SL-PRS. In some examples, for multi-channel access Type A for SL positioning, a UE needs to perform Type 1 channel access on each channel of a channel set. In some examples, for multi-channel access Type B for SL positioning, a UE only needs to perform Type 1 channel access on one channel of a channel set, other channels in the channel set only needs to perform Type 2 channel access (e.g. 25 usCCA).

In some examples, UE may consider the transmission frequency range of SL-PRS and/or the transmission frequency range of associated PSCCH to further determine whether multi-channel access can be applied and a number of channels to be accessed. The multi-channel access procedure (e.g., LBT procedure of each channel) begins at the same time but the actual SL positioning-related transmission time may be different. The transmission starting time/point of each channel involved in multi-channel access can be different. For example, PSCCH starts at symbol#1of a slot and occupies channel/RB set#1 only, but SL-PRS transmission starts at symbol#4 of a slot and occupies channel/RB set #1, 2 and 3. A UE performs multi-channel access for channel/RB set #1, 2 and 3, but the transmission starting point/time in channel/RB set#1 and the transmission in channel/RB set #2 and 3 are different.

In some examples, UE may or may not transmit SL-PRS only if the UE has successfully accessed all channels in the set of channels. In some examples, UE may transmit SL-PRS only if the UE has successfully accessed all channels in the set of channels. In some examples, the UE may transmit SL-PRS on those accessed channels in the set of channels, UE may only successfully access some channels in the set of channels.

In some arrangements, for SL positioning multi-channel access procedure, only if a UE has successfully accessed all channels in the set of channels, the UE may transmit SL-PRS on those channels. In some examples, transmitting SL-PRS on those channels is independent of whether the UE is configured with intra-cell guard band(s) or not. The UE may not transmit on a channel within the bandwidth of a carrier if the UE is configured without/with intra-cell guard band(s) on an SL bandwidth part, and the UE fails to access any of the channels of the UL bandwidth part.

In some examples, transmitting SL-PRS on those channels is dependent of whether the UE is configured with intra-cell guard band(s). The UE may not transmit on a channel within the bandwidth of a carrier if the UE is configured without intra-cell guard band(s) on an SL bandwidth part, and the UE fails to access any of the channels of the UL bandwidth part. The UE may transmit on a channel within the bandwidth of a carrier if the UE is configured without intra-cell guard band(s) on an SL bandwidth part, and the UE fails to access any of the channels of the UL bandwidth part.

In some arrangements, for SL positioning multi-channel access procedure, If UE only successfully accesses some channels in the set of channels, UE may transmit SL-PRS on those accessed channels. In some examples, only when UE successfully access one or more one contiguous RB sets can UE transmit SL-PRS on part of channels in the set of channels. For example, there are total 3 RB sets {0, 1, 2}, UE may transmit SL-PRS on RB set {0, 1} or {1,2} or {1,2,3} if they are successfully accessed. In some examples, only when UE successfully access more than (or equal to) N RB sets can UE transmit SL-PRS on part of channels in the set of channels. If less than N RB sets, UE does not transmit SL-PRS. With respect to configuring the value N, the UE or LMF may use SLPP or LPP respectively to request/configure the minimum number N. The BS may deliver the requested N value to UE via RRC or DCI or MAC CE. The number of N may be associated with server accuracy request.

In some arrangements, if non-contiguous RB sets are successfully accessed, the UE may transmit SL-PRS on transmit on one of those channels.

The priority of each channel can be configured or pre-configured where different RB set may have different priorities. UE or LMF may use SLPP or LPP respectively to request/configure the priority of each channel. BS may deliver the priority of channels to UE via RRC or DCI or MAC CE. In some examples, if the UE failed to access the highest-priority channel, the UE may not transmit on all channels in the set. In some examples in which non-contiguous RB sets are successfully accessed, and the UE transmits on one of those channels, if non-contiguous RB sets are successfully accessed, the UE may transmit on one of the channels, where this channel's priority is highest among all the successfully accessed channels. This can guarantee that anchor UEs can transmit SL-PRS and the target UE receives SL-PRS on the same RB set(s) and thus reducing the receiving error.

In some arrangements, the SCI includes a field to indicate RB set-level-resource-allocation in order to let Rx UE know Tx UE's frequency-domain channel occupancy. In some arrangements, for measurement report of SL positioning, SL-PRS resource ID information cannot represent the real SL-PRS resource allocation. Therefore, UE may associate its specific bandwidth information or RB set index(s) with SL positioning measurement(s). For measurement report to UE, the UE include the channel information in measurement report or location information report via SLPP; for measurement report to LMF, the UE include the channel information in measurement report or location information report via LPP. The channel information can be bandwidth, number of channels/RB sets, location of channels/RB sets, indexes of channels/RB sets.

In some arrangements, regarding the case when SCI/PSCCH and its associated SL-PRS are not in close proximity to each other, in other words, when at least there are symbol-level gap between SCI/PSCCH and its associated SL-PRS, SCI/PSCCH transmission N1 channels are successfully accessed, but for SL-PRS transmission only N2 channels are successfully accessed, where N2<=N1.

In some arrangements, if N2<N1, UE shall not transmit the corresponding SL-PRS. That means only when the same channels are accessed for both SCI/PSCCH transmission and SL-PRS transmission, can the UE transmit the SL-PRS. This can ensure that the SL-PRS frequency resource allocation indicated in SCI or the mapping between SCI and SL-PRS should remain accurate.

In some arrangements, if N2<N1, UE can still transmit the corresponding SL-PRS. In such case, the UE is informed that Tx UE may have different bandwidth for the SL-PRS bandwidth indicated in SCI/PSCCH and the actual bandwidth of SL-PRS. A 1-bit indicator can be included in SCI. For example, Rx UE does not expect a different or smaller bandwidth than frequency resource allocation or that according to the mapping between SCI and SL-PRS when it indicates “1”.

In some arrangements, the frequency domain allocation of PSCCH is different from that of its associated SL-PRS. In some examples, all the channels/RB sets assigned for a PSCCH resource are successfully accessed. A UE cannot transmit the PSCCH if only some of the channels/RB sets are sensed to be idle.

In some examples, only when both PSCCH and SL-PRS are successfully accessed, can the UE transmit the corresponding SL-PRS. The SL-PRS's bandwidth should be aligned with (e.g., equals to) what indicated in PSCCH or should be aligned with the mapping relationship between PSCCH and SL-PRS.

In some examples, even if the SL-PRS's bandwidth is not aligned with what indicated in PSCCH or is not aligned with the mapping relationship between PSCCH and SL-PRS, the UE can still transmit SL-PRS based on the rules, algorithms, and criteria described herein (e.g., higher priority channel, contiguous RB sets, and so on).

In some arrangements, a first frequency location of the channel for the SL positioning-related transmission is configured by a BS via RRC signaling. The first frequency location is different from a second frequency location for at least a DL transmission or an UL transmission.

In some arrangements, the method 400 further includes transmitting by the first UE the SL positioning-related transmission on the multiple channels in response to accessing the multiple channels successfully. The method 400 further includes transmitting by the first UE the SL positioning-related transmission on one or more continuous channels in response to accessing the one or more channels successfully. The method 400 further includes transmitting by the first UE the SL positioning-related transmission on one of two or more non-continuous channels in response to accessing the two or more non-continuous channels successfully. The method 400 further includes transmitting the SL positioning-related transmission based on multi-channel access result wherein the number of channels is based on the frequency resources of SL positioning-related transmission. The method 400 further includes transmitting the SL positioning-related transmission based on multi-channel access result. The transmission starting timing of SL-PRS and PSCCH can be the same or different.

In some arrangements, the first UE transmits the SL positioning-related transmission in response to determining the number of channels that the first wireless communication device accesses is greater than a threshold, wherein the threshold is configured by a LMF, a BS, a UE or by pre-configuration.

In some arrangements, multiple channels for transmitting the SL positioning-related transmission have different priorities, wherein the priority of each channel can be configured by an LMF or a BS, a third UE, or by pre-configuration.

In some arrangements, a measurement report or a location information report of the first wireless communication device to a third wireless communication device via SLPP or to an LMF via Long Term Evolution Positioning Protocol (LPP). The measurement report or a location information report includes at least one of a SL-PRS bandwidth, a number of channels, a channel index, or an indicator indicates different bandwidths in a bandwidth for transmitting the SL positioning-related transmission.

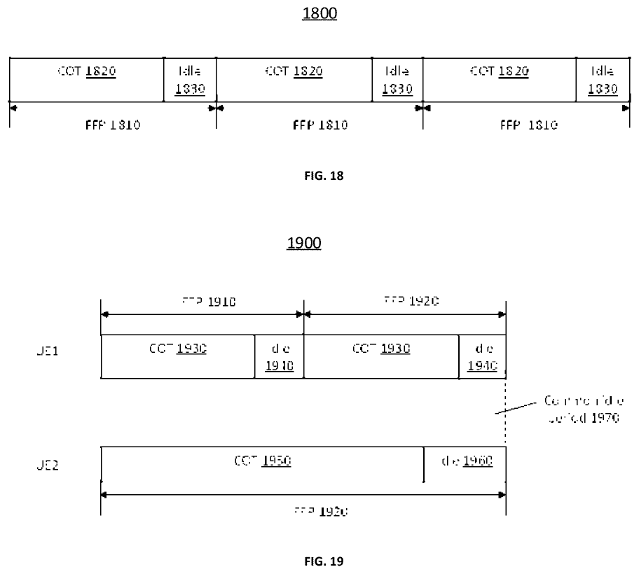

In some arrangements, in addition to dynamic channel access, a UE can also access one or more channel(s) via semi-static channel access procedure. FIG. 18 is a diagram illustrating semi-static channel access, according to various arrangements. For semi-static channel access, a period of duration T (e.g., FFP 1810) includes a COT duration 1820 at the beginning of the period and an idle duration 1830 at the end of the period.

In some arrangements, initiating a semi-static channel occupancy for SL positioning can include a semi-static channel occupancy initiated only by UE, a semi-static channel occupancy initiated by gNB or UE, a semi-static channel occupancy initiated only by gNB.

In some arrangements, the periodicity of semi-static channel access for SL positioning can be associated with SL-PRS configuration/characteristic(s). In some examples, the occasion of SL-PRS transmission is located within a COT duration instead of the idle period. For example, the periodicity or resource reservation period of SL-PRS is associated with or mapped to the periodicity of semi-static channel access. The periodicity or resource reservation period of SL-PRS can be configured as an integer multiple of or an integer factor of the periodicity of semi-static channel access.

In some examples, in which the semi-static channel occupancy is initiated only by UE, the location of the periodic COT is associated with or mapped to SL-PRS transmission occasion (time-domain). The time-domain features of SL-PRS include at least one of SL-PRS resource set slot offset, SL-PRS resource slot offset, SL-PRS resource symbol offset, SL-PRS resource starting slot number, SL-PRS resource starting symbol number, SL-PRS periodicity, or resource reservation period. For example, at least a SL-PRS resource and/or its associated PSCCH transmitted is at the beginning of an FFP period.

In some examples, the channel occupancy is initiated only by UE. A periodic channel occupancy can be initiated by the UE on one or more channel(s) every T every two consecutive radio frames, starting from the even indexed radio frame. In such case, only the period of channel occupancy T that a UE can initiate needs to be configured or pre-configured to UE. For resource allocation scheme 1, the period of channel occupancy T is configured or pre-configured by the BS via RRC or DCI or MAC CE. For resource allocation scheme 2, the UE selects its own SL-PRS transmission resources. In some examples, the UE is still in the BS's coverage, and the period of channel occupancy T that a UE can initiate is either configured by the BS via RRC or determined by the UE itself based on its SL-PRS transmission needs. In some examples, the UE is out-of-BS's-coverage, and the UE itself determines the period of channel occupancy T based on its SL-PRS transmission needs. For resource allocation scheme 2, another UE (e.g. server UE) can configure or pre-configure the period of semi-static channel occupancy and send it to the UE via SLPP or PC5-RRC or SL MAC CE or SCI. Either configured or pre-configured or determined by the UE itself, at least a PSCCH and/or SL-PRS transmission occasion starts from the even indexed radio frame.

In some arrangements, a periodic channel occupancy can be initiated by the UE on one or more channel(s) every T, starting from any frame or slot or symbol. In other words, there can be an offset between a periodic channel occupancy's starting point and even indexed radio frame. For resource allocation scheme 1, the period of channel occupancy T and an offset are configured by gNB via RRC or DCI or MAC CE. For resource allocation scheme 2, the UE selects its own SL-PRS transmission resources. In some examples, the UE is still in BS's coverage, and the period of channel occupancy T that a UE can initiate and an offset are either configured by BS via RRC or determined by the UE itself based on its SL-PRS transmission needs. In some examples, the UE is out-of-BS's-coverage, and the UE itself determines the period of channel occupancy T and an offset based on its SL-PRS transmission needs. For resource allocation scheme 2, another UE (e.g., a server UE) can configure or pre-configure the period of semi-static channel occupancy and an offset and send it to the UE via SLPP or PC5-RRC or SL MAC CE or SCI.

In some arrangements in which a UE transmits SL-PRS resource(s) in resource allocation scheme 1, an LMF can be involved in recommending or configuring the period of channel occupancy and/or an offset it to UE via LPP. In some arrangements, the LMF can recommend or indicate or configure the period of channel occupancy and/or an offset of a UE and send it to BS via NRPPa. The BS can deliver such information to the UE via RRC.

In some arrangements, the LMF or the BS can align the idle period of different UEs. For example, different UEs may have different semi-static channel occupancy periodicities and their idle period can be located in different places. To minimize/avoid LBT failures as much as possible, the LMF or BS can align the location of idle period of different UEs.

In some examples, the BS configure semi-static channel access configurations (e.g. periodicity, start timing, idle period location) for different UEs via RRC or DCI or MAC CE. In some examples, UE may request BS to provide aligned semi-static channel access configuration via RRC or DCI or MAC CE. In some examples, the UE may request LPP to provide aligned semi-static channel access configuration via LPP. In some examples, the LMF may send a request message via NRPPa to trigger BS(s) to provide the semi-static channel access configurations of UE. In some examples, the BS can send the semi-static channel access configurations of different UEs to LMF. In some examples, LMF can resolve the potential LBT failure by implementation, for example, LMF can change the start timing of semi-static period of a UE in order to align with other UEs timing. In some examples, LMF sends the recommended or modified semi-static channel access configurations for different UEs to BS and the BS itself determines and distributes the semi-static channel access configurations to UEs. In some examples, the LMF can provide the semi-static channel access configurations to UE via LPP. In some examples in which UEs are under different BS's coverage, the LMF can send a request message to BS(s) and request BS to semi-static channel access configurations of UEs under other BS's coverage/control. In some examples, the BS can send semi-static channel access configurations of UEs under its own coverage to other BS via Xn interface. After receiving semi-static channel access configurations of UEs under other BSs' coverage, the BS can configure the timing of semi-static according and make sure different UEs' idle period can overlap as much as possible.

In some arrangements, a UE (e.g. server UE) can be used to align the idle period of different UEs. Some arrangements relate to out-of-coverage scenarios when LMF or BS cannot coordinate the semi-static channel access timing. In some examples, a UE configure semi-static channel access configurations (e.g., periodicity, start timing, idle period location) for different UEs via SLPP or SL MAC CE, SCI. In some examples, a UE may request another UE to provide aligned semi-static channel access configuration via SLPP or SL MAC CE or SCI. In some examples, a UE may send a request message via SLPP or SL MAC CE or SCI to trigger UE(s) to provide the semi-static channel access configurations.

FIG. 19 is a diagram illustrating semi-static channel access for two UEs (UE1 and UE2), according to various arrangements. As shown in FIG. 19, UE 2's periodicity of semi-static channel access is twice the periodicity of UE1. For example, the FFP 1920 (one semi-static channel access period) of UE2 has a length equal to two semi-static channel access periods of UE1, including FFP 1910 and 1920. Each of the FFP 1910 and 1920 includes a COT 1930 and an idle duration 1940. The FFP 1920 includes COT 1950 and idle duration 1960. A common idle period 1970 exists in the idle duration 1940 of FFP 1920 and the idle duration 1960 of FFP 1920. The BS, LMF, or UE can attempt to increase the common idle period 1970 as much as possible.

In some arrangements, the channel access procedure is semi-static and has a periodicity mapped to a configuration or a characteristic of the SL PRS. The configuration or characteristic of the SL PRS includes at least one of SL-PRS resource set slot offset, SL-PRS resource slot offset, SL-PRS resource symbol offset, SL-PRS resource starting slot number, SL-PRS resource starting symbol number, SL-PRS periodicity, or resource reservation period.

In some arrangements, a semi-static channel access configuration including the periodicity is determined by the first UE or is configured by a UE (e.g., a third UE) via at least one of SLPP signaling, PC5-RRC signaling, SL MAC CE, or SCI, by a BS via at least one of RRC signaling, DCI, or MAC CE, or by an LMF via LPP.

In some arrangements, a period of semi-static channel access includes a COT duration and an idle period, different UEs can have different semi-static channel access configurations, the idle period of different wireless communication devices are aligned by a UE (e.g., a third UE) via at least one of SLPP signaling, PC5-RRC signaling, SL MAC CE, or SCI, by a BS via at least one of RRC signaling, DCI, or MAC CE, or by an LMF via LPP.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
performing, by a first wireless communication device, a channel access procedure for at least one channel; and
communicating, by the first wireless communication device with the second wireless communication device, SL positioning-related transmission using the at least one channel, wherein the SL positioning-related transmission comprises at least one of a SL Positioning Reference Signal (SL-PRS) or a Physical Shared Control Channel (PSCCH) corresponding to the SL PRS.

2. The method of claim 1, wherein
the channel access procedure comprises a Type 1 channel access for determining SL positioning of the first wireless communication device in an unlicensed band;
a Channel Access Priority Class (CAPC) used in the Type 1 channel access of the SL positioning of the first wireless communication device corresponds to a Listen Before Talk (LBT) time duration and a maximum Channel Occupancy Time (COT); and
the CAPC corresponds to a configuration or a characteristic of the SL PRS.

3. The method of claim 2, further comprising receiving, by the first wireless communication device, an indication, a configuration, or a pre-configuration of a CAPC value or a CAPC index corresponding to the CAPC as the configuration or the characteristic of the SL PRS;
preferably, wherein at least one of the CAPC value is configured or pre-configured for each resource pool, or for each SL-PRS resource set, or for each SL-PRS resource;
preferably, wherein at least one of: the CAPC is received by the first wireless communication device from a Base Station (BS) via at least one of Radio Resource Control (RRC) signaling, a Downlink Control Information (DCI), or a Medium Access Control (MAC) Control Element (CE);
the CAPC is received by the first wireless communication device from the second wireless communication device or a third wireless communication device via at least one of Sidelink Positioning Protocol (SLPP) signaling, PC5-RRC signaling, SL MAC CE, or Sidelink Control Information (SCI); or
the CAPC is received by the first wireless communication device from a Location Management Function (LMF) via Long Term Evolution Positioning Protocol (LPP);
preferably, further comprising determining, by the first wireless communication device, the CAPC value or the CAPC index using a mapping between: CAPC values or CAPC indices; and the configuration or the characteristic of the SL PRS.

4-8. (canceled)

9. The method of claim 2, further comprising receiving, by the first wireless communication device, a Channel Access Priority Class (CAPC) of the SL positioning of the first wireless communication device, wherein at least one of:
the CAPC is received by the first wireless communication device from a Base Station (BS) via at least one of Radio Resource Control (RRC) signaling, a Downlink Control Information (DCI), or a Medium Access Control (MAC) Control Element (CE);
the CAPC is received by the first wireless communication device from the second wireless communication device or a third wireless communication device via at least one of Sidelink Positioning Protocol (SLPP) signaling, PC5-RRC signaling, SL MAC CE, or Sidelink control information (SCI); or
the CAPC is received by the first wireless communication device from a Location Management Function (LMF) via Long Term Evolution Positioning Protocol (LPP);
preferably, wherein the first wireless communication device receives the CAPC from the LMF; and at least one of:
the BS sends the CAPC and SL-PRS configuration corresponding to the CAPC to the LMF via a first New Radio Positioning Protocol A (NRPPa) signaling;
the LMF receives information from a plurality of BSs and requests the plurality of BSs to adjust CAPC values via a second NRPPa signaling;
the plurality of BSs adjust the CAPC values and send adjusted configuration corresponding to the adjusted CAPC values to the LMF via a third NRPPa signaling; and
the LMF distributes the adjusted configuration to the UE via Long Term Evolution Positioning Protocol (LPP) signaling.

10. (canceled)

11. The method of claim 2, further comprising determining, by the first wireless communication device, a CAPC value for the SL positioning-related transmission using CAPC values contained in at least one of MAC CE, Common Control Channel (CCCH) Service Data Unit (SDU), Dedicated Control Channel (DCCH) SDU, MAC SDUs, or SL Shared Channel (SL-SCH) subheader.

12. The method of claim 1, further comprising initiating, by the first wireless communication device, channel occupancy for two or more SL transmissions by determining unified CAPC value, wherein the SL transmissions comprise at least one of the SL-PRS or a SL data transmission.

13. The method of claim 1, further comprising:
performing, by the first wireless communication device, a Clear Channel Assessment (CCA) for a LBT time duration according to a Contention window (CW) size; and
accessing, by the first wireless communication device, one or more SL channels for SL positioning with or without adjusting the CW size.

14. The method of claim 13, wherein
the first wireless communication device accesses the one or more SL channels without adjusting the CW size; and
at least one of:
each Channel Access Priority Class (CAPC) value is associated with a fixed CW size;
each CAPC value is associated with two or more CW sizes, the first wireless communication device randomly selects one candidate CW size from the two or more CW sizes for transmitting a respective SL-PRS;
each CAPC value is associated with two or more CW sizes, the first wireless communication device uses a CW size for the channel access procedure as indicated or configured by at least one of a Base Station (BS), the second wireless communication device, a third wireless communication device, or an LMF.

15. The method of claim 13, further comprising adjusting, by the first wireless communication device, the CW size using a channel assessment result;
preferably, further comprising:
receiving, by the first wireless communication device from the second wireless communication device, measurement results of the SL-PRS or measurement results of the PSCCH of the second wireless communication device via at least one of Sidelink Positioning Protocol (SLPP) signaling, PC5-Radio Resource Control (RRC) signaling, SL Medium Access Control (MAC) Control Element (CE), or Sidelink control information (SCI);
adjusting or maintaining, by the first wireless communication device, the CW size by comparing the measurement results of the SL-PRS or the measurement results of the PSCCH of the second wireless communication device and a measurement threshold;
preferably, further comprising receiving, by the first wireless communication device from the second wireless communication device via at least one of Sidelink Positioning Protocol (SLPP) signaling, PC5-Radio Resource Control (RRC) signaling, SL Medium Access Control (MAC) Control Element (CE), or Sidelink control information (SCI), an indication indicating whether to adjust the CW size and an adjustment information for adjusting the CW size.

16-17. (canceled)

18. The method of claim 13, wherein
each Channel Access Priority Class (CAPC) value or a configuration or a characteristic of the SL PRS is mapped to two or more CW sizes; and
the method further comprises one of:
receiving, by the first wireless communication device from the second wireless communication device via at least one of Sidelink Positioning Protocol (SLPP) signaling, PC5-Radio Resource Control (RRC) signaling, SL Medium Access Control (MAC) Control Element (CE), or Sidelink Control Information (SCI), an indication indicating whether to adjust the CW size and an adjustment information for adjusting the CW size;
determining, by the first wireless communication device, whether to adjust the CW size and the adjustment information for adjusting the CW size; or
receiving, by the first wireless communication device from a Base Station (BS) via at least one of Radio Resource Control (RRC) signaling, a Downlink Control Information (DCI), or a Medium Access Control (MAC) Control Element (CE), an indication indicating whether to adjust the CW size and the adjustment information for adjusting the CW size; or
receiving, by the first wireless communication device from an LMF via Long Term Evolution Positioning Protocol (LPP) an indication indicating whether to adjust the CW size and the adjustment information for adjusting the CW size.

19. The method of claim 13, further comprising:
adjusting, by the first wireless communication device, the CW size by adjusting a Channel Access Priority Class (CAPC) value; and
the method further comprises one of:
receiving, by the first wireless communication device from the second wireless communication device via at least one of Sidelink Positioning Protocol (SLPP) signaling, PC5-Radio Resource Control (RRC) signaling, SL Medium Access Control (MAC) Control Element (CE), or Sidelink control information (SCI), an indication indicating whether to adjust the CAPC value and an adjustment information for adjusting the CAPC value;
determining, by the first wireless communication device, whether to adjust the CAPC value and the adjustment information for adjusting the CAPC value; or
receiving, by the first wireless communication device from a Base Station (BS) via at least one of Radio Resource Control (RRC) signaling, a Downlink Control Information (DCI), or a Medium Access Control (MAC) Control Element (CE), an indication indicating whether to adjust the CAPC value and the adjustment information for adjusting the CAPC value; or
receiving, by the first wireless communication device from a Location Management Function(LMF) via Long Term Evolution Positioning Protocol (LPP), an indication indicating whether to adjust the CAPC value and the adjustment information for adjusting the CAPC value;
preferably, wherein determining whether to adjust the CAPC value and the adjustment information for adjusting the CAPC value is based on one of: LBT failure time, initial transmission or retransmission for SL positioning, or channel condition.

20. (canceled)

21. The method of claim 1, wherein
the channel access procedure comprises a Type 2 channel access for determining SL positioning of the first wireless communication device in an unlicensed band, before the SL positioning-related transmission; and
the method further comprises sensing, by the first wireless communication device, a time duration of at least one sensing slot for a Listen Before Talk (LBT) is idle before the SL positioning-related transmission wherein the LBT time duration is deterministic.

22. The method of claim 21, further comprising determining that the first wireless communication device can use Type 2 channel access based on at least one of a time duration for the SL positioning-related transmission, a duty cycle, a SL-PRS priority, a Channel Access Priority Class, CAPC,, a periodicity, or a number of symbols within a slot.

23. The method of claim 21, further comprising receiving, by the first wireless communication device from the second wireless communication device or a third wireless communication device, Channel Occupancy Time (COT) sharing information for the SL positioning, the COT sharing information comprises at least one of time-domain information of a COT, a frequency-domain information of the COT, one or more UE pair information, a Channel Access Priority Class (CAPC) of the first wireless communication device, SL-PRS priority of the first wireless communication device, or a common COT indicator, or a group ID;
preferably, wherein the COT sharing information is contained in a Sidelink Control Information (SCI), the SCI comprises a field indicating whether a reserved SL-PRS resource of the first wireless communication device can be used for transmitting the SL-PRS according to whether the reserved SL-PRS resource is within a second wireless communication device's initiated COT, and either a new field or an SL-PRS request field in the SCI is used for the indication;
preferably, wherein the COT sharing information is contained in at least one of a Medium Access Control (MAC) Control Element (CE) or Sidelink Positioning Protocol (SLPP) signaling;
preferably, wherein at least one of:
the CAPC value for the SL positioning transmission of the first wireless communication device is equal to or less than a CAPC value that the second wireless communication device or third wireless communication device use for initiating the COT;
the SL-PRS transmission priority value for the first wireless communication device is equal to or less than the SL-PRS transmission priority value that the second wireless communication device or third wireless communication device use for initiating the COT;
the SL-PRS of the second wireless communication device or third wireless communication device is transmitted to the first wireless communication device;
the SL-PRS of the first wireless communication device in the shared COT is transmitted to the second wireless communication device or third wireless communication device;
the SL-PRS of the first wireless communication device and the SL-PRS of the third wireless communication device in the shared COT are transmitted to the same second wireless communication device.

24-26. (canceled)

27. The method of claim 1, wherein
a Base Station (BS) initiates a Channel Occupancy Time (COT) and shares the COT with the first wireless communication device for the SL positioning-related transmission; and the SL positioning-related transmission is scheduled or configured by the BS;
preferably, the BS shares the COT with the first wireless communication device using at least one of Radio Resource Control (RRC) signaling, a Downlink Control Information (DCI), or a Medium Access Control (MAC) Control Element (CE), wherein information for sharing the COT comprises at least one of:
an indicator indicating whether the COT is used for SL positioning related transmission;
frequency domain of the COT;
time domain of the COT;
Physical Uplink Control Channel (PUCCH) feedback related indication;
channel access type or Channel Access Priority Class (CAPC); or
CP extension length related indication.

28. (canceled)

29. The method of claim 1, the first wireless communication device shares its COT after channel access success with a base station (BS) for DL transmission via uplink control information (UCI);
or
a first frequency location of the channel for the SL positioning-related transmission is configured by a Base Station (BS) via Radio Resource Control (RRC) signaling, wherein the first frequency location is different from a second frequency location for at least a Downlink (DL) transmission or an Uplink (UL) transmission.

30. (canceled)

31. The method of claim 1, wherein at least one of:
the method further comprising transmitting the SL positioning-related transmission on the multiple channels in response to accessing the multiple channels successfully;
the method further comprising transmitting the SL positioning-related transmission on one or more continuous channels in response to accessing the one or more channels successfully;
the method further comprising transmitting the SL positioning-related transmission on one of two or more non-continuous channels in response to accessing the two or more non-continuous channels successfully;
the method further comprising transmitting the SL positioning-related transmission based on multi-channel access result wherein the number of channels is based on the frequency resources of SL positioning-related transmission;
the method further comprising transmitting the SL positioning-related transmission based on multi-channel access result wherein the transmission starting timing of SL-PRS and PSCCH can be the same or different;
preferably, wherein the first wireless communication device transmits the SL positioning-related transmission in response to determining the number of channels that the first wireless communication device accesses is greater than a threshold, wherein the threshold is configured by a Location Management Function (LMF) or a Base Station (BS) or a third wireless communication device or by pre-configuration;
preferably, wherein multiple channels for transmitting the SL positioning-related transmission have different priorities, wherein the priority of each channel can be configured by a Location Management Function (LMF) or a Base Station (BS), a third wireless communication device, or by pre-configuration;
preferably, wherein a measurement report or a location information report of the first wireless communication device to a third wireless communication device via Sidelink Positioning Protocol (SLPP) or to a Location Management Function (LMF) via Long Term Evolution Positioning Protocol (LPP), wherein the measurement report or a location information report comprises at least one of:
a SL-PRS bandwidth;
a number of channels;
a channel index;
an indicator indicates different bandwidths in a bandwidth for transmitting the SL positioning-related transmission.

32-34. (canceled)

35. The method of claim 1, wherein the channel access procedure is semi-static and has a periodicity mapped to a configuration or a characteristic of the SL PRS, wherein the configuration or characteristic of the SL PRS includes at least one of: SL-PRS resource set slot offset, SL-PRS resource slot offset, SL-PRS resource symbol offset, SL-PRS resource starting slot number, SL-PRS resource starting symbol number, SL-PRS periodicity or resource reservation period;
preferably, semi-static channel access configuration including the periodicity is determined by the first wireless communication device or is configured by:
a wireless communication device via at least one of Sidelink Positioning Protocol (SLPP) signaling, PC5-Radio Resource Control (RRC) signaling, SL Medium Access Control (MAC) Control Element (CE), or Sidelink control information (SCI);
a Base Station (BS) via at least one of Radio Resource Control (RRC) signaling, a Downlink Control Information (DCI), or a Medium Access Control (MAC) Control Element (CE); or
a Location Management Function (LMF) via Long Term Evolution Positioning Protocol (LPP);
preferably, a period of semi-static channel access includes a COT duration and an idle period, different UEs can have different semi-static channel access configurations, the idle period of different wireless communication devices are aligned by:
a wireless communication device via at least one of Sidelink Positioning Protocol (SLPP) signaling, PC5-Radio Resource Control (RRC) signaling, SL Medium Access Control (MAC) Control Element (CE), or Sidelink control information (SCI);
a Base Station (BS) via at least one of Radio Resource Control (RRC) signaling, a Downlink Control Information (DCI), or a Medium Access Control (MAC) Control Element (CE); or
a Location Management Function (LMF) via Long Term Evolution Positioning Protocol (LPP).

36-37. (canceled)

38. A wireless communication apparatus comprising at least one processor and a memory, wherein the at least one processor is configured to read code from the memory and implement:
performing, by a first wireless communication device, a channel access procedure for at least one channel; and
communicating, by the first wireless communication device with the second wireless communication device, SL positioning-related transmission using the at least one channel, wherein the SL positioning-related transmission comprises at least one of a SL Positioning Reference Signal (SL-PRS) or a Physical Shared Control Channel (PSCCH) corresponding to the SL PRS.

39. A computer program product comprising a computer-readable program medium code stored thereupon, the code, when executed by at least one processor, causing the at least one processor to implement:
performing, by a first wireless communication device, a channel access procedure for at least one channel; and
communicating, by the first wireless communication device with the second wireless communication device, SL positioning-related transmission using the at least one channel, wherein the SL positioning-related transmission comprises at least one of a SL Positioning Reference Signal (SL-PRS) or a Physical Shared Control Channel (PSCCH) corresponding to the SL PRS.
